(19) United States
(12) Patent Application Publication
(10) Pub. No.: US 2011/0202300 A1
(43) Pub. Date: Aug. 18, 2011

(54) METHOD FOR CREATING CORRECTION PARAMETER FOR POSTURE DETECTING DEVICE, DEVICE FOR CREATING CORRECTION PARAMETER FOR POSTURE DETECTING DEVICE, AND POSTURE DETECTING DEVICE

(75) Inventors: Hirofumi Udagawa, Ina (JP); Yoshihiro Kobayashi, Komagane (JP)

(73) Assignee: EPSON TOYOCOM CORPORATION, Tokyo (JP)

(21) Appl. No.: 13/126,446

(22) PCT Filed: Nov. 12, 2009
(86) PCT No.: PCT/JP2009/069249

§ 371 Date: Apr. 27, 2011

(30) Foreign Application Priority Data
Nov. 13, 2008 (JP) 2008-291213

(51) Int. Cl. G06F 19/00

(52) U.S. Cl. 702/95

(57) ABSTRACT

A turntable (230) is installed so that an upper side (231) of the turntable is horizontal (S10). A posture detection device (1) is secured on a side (211) of a cubic jig (210) so that an X-axis (first axis) perpendicularly intersects a side (212) (second side), a Y-axis (second axis) perpendicularly intersects a side (213) (third side), and a Z-axis (third axis) perpendicularly intersects the side (211) (first side) (S12). The side of the cubic jig opposite to the side (212), (213), or (211) is sequentially secured on the upper side of the turntable (S14, S20, and S26). Detection values of the posture detection device are acquired in a state in which the turntable is stationary or rotated at a predetermined angular velocity (S16, S18, S22, S24, S28, and S30), and correction parameters are created (S32).

### TECHNICAL FIELD

The present invention relates to a correction parameter creation method that generates correction parameters for correcting detection values of a posture detection device including sensors that detect three-axis angular velocities or three-axis accelerations to detection values in a predetermined orthogonal coordinate system, a correction parameter creation device, and a posture detection device having a correction function.

### BACKGROUND ART

A posture detection device that detects the posture of an object using angular velocity sensors or acceleration sensors has been used for various applications. For example, JP-A-9-106322 discloses a head mount display that detects the posture of the head of the user, and changes an image displayed on the display in synchronization with the movement of the head of the user so that the user can experience a virtual space. The head mount display disclosed in JP-A-9-106322 displays an image based on the posture angle of the head of the user. A posture detection device that includes angular velocity sensors or acceleration sensors and detects the posture angle is mounted at a predetermined position of the head mount display. If the posture detection device is not mounted so that the detection axes of the sensors are parallel to three axes of an orthogonal coordinate system that indicates the posture angle of the head, the detection values of the posture detection device include an error due to the installation angle errors. Therefore, the installation position and the installation angle of the posture detection device are strictly specified.

### SUMMARY OF INVENTION

### Technical Problem

However, if the sensors are mounted in the posture detection device with small installation angle errors, highly accurate detection results cannot be obtained even if the installation position and the installation angle of the posture detection device are strictly specified. It is impractical to eliminate the installation angle errors of the sensors from the viewpoint of cost. Therefore, the installation angle errors are calculated in advance, and the detection values of the posture detection device are corrected using correction parameters corresponding to the installation angle errors. The following expressions (1) and (2) respectively indicate a correction expression for the angular velocity sensor and a correction expression for the acceleration sensor using a correction parameter.

f_{G}(x)=f_{G}(p)+J_{f}_{_{G}}(p)(x−p)+o(|x|) (1)

f_{A}(x)=f_{A}(p)+J_{f}_{_{A}}(p)(x−p)+o(|x|) (2)

In the expression (1), the functional determinant (Jacobian) J_{fG} is a correction parameter for the angular velocity sensor, and f_{G}(x) and f_{G}(p) are the current and preceding corrected values (ideal values) of the angular velocity sensor, respectively. In the expression (2), the functional determinant (Jacobian) J_{fA} is a correction parameter for the acceleration sensor, and f_{A}(x) and f_{A}(p) are the current and preceding corrected values (ideal values) of the acceleration sensor, respectively. In the expressions (1) and (2), x and p are the current and preceding detection values of the angular velocity sensor or the acceleration sensor, and o is Landau's symbol.

Since the installation angle error of the sensor differs depending on the posture detection device, the correction parameters (J_{fG} and J_{fA}) of the expressions (1) and (2) are provided for each posture detection device during a test before shipment, for example. FIGS. 13A to 13C and 14A to 14C illustrate a related-art method that creates the correction parameters (J_{fG} and J_{fA}). Specifically, the posture detection device is placed in a socket 520 secured on a table 510. A rotary arm 530 is rotated at a predetermined angular velocity around the X-axis, the Y-axis, and the Z-axis (see FIGS. 13A to 13C) to acquire the detection values of the posture detection device. The correction parameter for the angular velocity sensor is obtained by solving simultaneous equations obtained by substituting the detection values and the ideal values into the expression (1). As illustrated in FIGS. 14A to 14C, the rotary arm 530 is stopped in a state in which the positive X-axis direction, the positive Y-axis direction, or the positive Z-axis direction coincides with the vertically upward direction (i.e., a gravitational acceleration is applied vertically downward) to acquire the detection values of the posture detection device. The correction parameter for the acceleration sensor is obtained by solving simultaneous equations obtained by substituting the detection values and the ideal values into the expression (2).

When operating the rotary arm 530 illustrated in FIGS. 13A to 13C and 14A to 14C, the detection values that accurately reflect the installation angle errors of the angular velocity sensor and the acceleration sensor cannot be acquired if the table 510 is not accurately secured at a predetermined angle with respect to the X-axis, the Y-axis, and the Z-axis. However, it may be necessary to increase the size of a correction parameter creation device 500 that includes the table 510 and the rotary arm 530 in order to accurately secure the table 510 at a predetermined angle with respect to the X-axis, the Y-axis, and the Z-axis. Moreover, it takes considerable time to accurately secure the table 510 at a predetermined angle with respect to the X-axis, the Y-axis, and the Z-axis. When creating the correction parameters for a posture detection device that includes both the angular velocity sensors and the acceleration sensors, it is necessary to separately operate the rotary arm 530 as illustrated in FIGS. 13A to 13C and 14A to 14C. This further increases the operation time. Therefore, the correction parameters cannot be provided inexpensively when using the related-art method.

The invention was conceived in view of the above problems. Several aspects of the invention may provide a correction parameter creation method for a posture detection device that can inexpensively create correction parameters for correcting errors in detection values due to installation angle errors of sensors, a correction parameter creation device that can be inexpensively implemented, and a posture detection device having a correction function.

### Solution to Problems

(1) According to the invention, there is provided a correction parameter creation method that creates correction parameters of a correction expression that corrects detection values of a posture detection device to detection values in an orthogonal coordinate system having a first axis, a second axis, and a third axis that perpendicularly intersect as coordinate axes, the posture detection device including a first sensor, a second sensor, and a third sensor that are mounted so that their detection axes are almost parallel to the first axis, the second axis, and the third axis, respectively, and detect an angular velocity or an acceleration, and detecting a posture of an object based on detection signals from the first sensor, the second sensor, and the third sensor, the correction parameter creation method including:

a step of installing a turntable so that an upper side of the turntable is horizontal;

a step of securing the posture detection device on a first side of a jig that is formed in a shape of a rectangular parallelepiped and includes the first side, a second side, and a third side that perpendicularly intersect so that the first axis perpendicularly intersects the second side, the second axis perpendicularly intersects the third side, and the third axis perpendicularly intersects the first side;

a first detection value acquisition step of securing a side of the jig opposite to the second side on the upper side of the turntable, and acquiring the detection values of the posture detection device in a state in which the turntable is stationary or rotated at a predetermined angular velocity;

a second detection value acquisition step of securing a side of the jig opposite to the third side on the upper side of the turntable, and acquiring the detection values of the posture detection device in a state in which the turntable is stationary or rotated at a predetermined angular velocity;

a third detection value acquisition step of securing a side of the jig opposite to the first side on the upper side of the turntable, and acquiring the detection values of the posture detection device in a state in which the turntable is stationary or rotated at a predetermined angular velocity; and

a correction parameter creation step of creating the correction parameters based on the acquired detection values.

When the orthogonal coordinate system has an X-axis, a Y-axis, and a Z-axis as the coordinate axes, the first axis, the second axis, and the third axis may have an arbitrary relationship with the X-axis, the Y-axis, and the Z-axis.

Since the above correction parameter creation method uses the jig that is formed in the shape of a rectangular parallelepiped, the posture detection device can be easily secured on the first side so that the first axis, the second axis, and the third axis perpendicularly intersect the first side, the second side, and the third side of the jig, respectively. Since the turntable is installed so that the upper side of the turntable is horizontal, the first axis, the second axis, or the third axis can be easily made parallel to the vertical direction by merely securing the side of the jig opposite to the second side, the third side, or the first side on the upper side of the turntable. The detection values of the acceleration sensors or the angular velocity sensors can be easily and quickly acquired by stopping or rotating the turntable in a state in which the first axis, the second axis, or the third axis is parallel to the vertical direction.

Specifically, since the rotation direction of the turntable is fixed by initially installing the turntable so that the upper side is horizontal, the setting time for acquiring the detection values about the X-axis, the Y-axis, and the Z-axis can be significantly reduced. Therefore, the correction parameters for correcting errors in the detection values due to the installation angle errors of the sensors can be inexpensively created.

(2) In the above correction parameter creation method,

the correction expression may include a first correction matrix, a second correction matrix, and a third correction matrix as the correction parameters, the first correction matrix, the second correction matrix, and the third correction matrix correcting the detection values of the first sensor, the second sensor, and the third sensor to the detection values in the orthogonal coordinate system, and the correction expression may be the sum of three matrices obtained by the product of the first correction matrix and a matrix that includes a digital value obtained by A/D-converting the detection value of the first sensor as an element, the product of the second correction matrix and a matrix that includes a digital value obtained by A/D-converting the detection value of the second sensor as an element, and the product of the third correction matrix and a matrix that includes a digital value obtained by A/D-converting the detection value of the third sensor as an element.

(3) In the above correction parameter creation method,

the first correction matrix may be an inverse matrix of a rotation matrix that transforms the detection axis of the first sensor into the first axis, the second correction matrix may be an inverse matrix of a rotation matrix that transforms the detection axis of the second sensor into the second axis, and the third correction matrix may be an inverse matrix of a rotation matrix that transforms the detection axis of the third sensor into the third axis.

(4) In the above correction parameter creation method,

the correction parameter creation step may include:

calculating installation angle errors of the second sensor and the third sensor around the first axis based on the detection values acquired in the first detection value acquisition step;

calculating installation angle errors of the first sensor and the third sensor around the second axis based on the detection values acquired in the second detection value acquisition step;

calculating installation angle errors of the first sensor and the second sensor around the third axis based on the detection values acquired in the third detection value acquisition step;

creating the first correction matrix based on the installation angle error of the first sensor around the second axis and the installation angle error of the first sensor around the third axis;

creating the second correction matrix based on the installation angle error of the second sensor around the first axis and the installation angle error of the second sensor around the third axis; and

creating the third correction matrix based on the installation angle error of the third sensor around the first axis and the installation angle error of the third sensor around the second axis.

(5) According to the invention, there is provided a correction parameter creation device that is used to create correction parameters of a correction expression that corrects detection values of a posture detection device to detection values in an orthogonal coordinate system having a first axis, a second axis, and a third axis that perpendicularly intersect as coordinate axes, the posture detection device including a first sensor, a second sensor, and a third sensor that are mounted so that their detection axes are almost parallel to the first axis, the second axis, and the third axis, respectively, and detect an angular velocity or an acceleration, and detecting a posture of an object based on detection signals from the first sensor, the second sensor, and the third sensor, the correction parameter creation device including:

a jig that is formed in a shape of a rectangular parallelepiped, and includes a first side, a second side, and a third side that perpendicularly intersect, the jig being configured so that the posture detection device can be secured on the first side such that the first axis perpendicularly intersects the second side, the second axis perpendicularly intersects the third side, and the third axis perpendicularly intersects the first side;

a turntable having an upper side on which a side of the jig opposite to the first side, the second side, or the third side can be secured; and

a rotation control section that rotates the turntable at a predetermined angular velocity.

According to the above correction parameter creation device, since a rotary arm is not required as a result of using the jig formed in the shape of a rectangular parallelepiped and the turntable, it is possible to provide a correction parameter creation device that is compact and inexpensive. The correction parameters for the detection values of the sensors provided in the posture detection device can be easily and quickly acquired by utilizing the above correction parameter creation device.

(6) According to the invention, there is provided a posture detection device including:

a first sensor, a second sensor, and a third sensor that are mounted so that their detection axes are almost parallel to a first axis, a second axis, and a third axis that perpendicularly intersect, respectively, and detect an angular velocity or an acceleration;

a storage section that stores correction parameters of a correction expression that corrects detection values of the first sensor, the second sensor, and the third sensor to detection values in an orthogonal coordinate system having the first axis, the second axis, and the third axis as coordinate axes;

an A/D conversion section that converts detection signals from the first sensor, the second sensor, and the third sensor into digital signals; and

a correction calculation section that calculates the correction expression based on the digital signals and the correction parameters,

the correction expression including a first correction matrix, a second correction matrix, and a third correction matrix as the correction parameters, the first correction matrix, the second correction matrix, and the third correction matrix correcting the detection values of the first sensor, the second sensor, and the third sensor to the detection values in the orthogonal coordinate system, and being the sum of three matrices obtained by the product of the first correction matrix and a matrix that includes a digital value obtained by A/D-converting the detection value of the first sensor as an element, the product of the second correction matrix and a matrix that includes a digital value obtained by A/D-converting the detection value of the second sensor as an element, and the product of the third correction matrix and a matrix that includes a digital value obtained by A/D-converting the detection value of the third sensor as an element.

The functional determinants (Jacobian) in the correction expressions (1) and (2) are not correction parameters that directly reflect the installation angle error of the sensor. When using the correction expressions (1) and (2), since the current detection value is estimated using the functional determinant (Jacobian) based on the preceding detection value, a corrected value is not obtained when the detection value is mapped. Therefore, an increase in correction accuracy is limited when using the correction expressions (1) and (2).

According to the above posture detection device, the installation angle errors of the sensors can be directly reflected in the correction matrices included in the correction expression calculated by the correction calculation section. Moreover, since the correction expression calculated by the correction calculation section does not require the preceding detection value when calculating the corrected values corresponding to the current detection values, the corrected values can be immediately calculated when the current detection values have been obtained. Therefore, a posture detection device that achieves high correction accuracy and a high correction calculation speed can be implemented.

(7) In the above posture detection device,

the first correction matrix may be an inverse matrix of a rotation matrix that transforms the detection axis of the first sensor into the first axis, the second correction matrix may be an inverse matrix of a rotation matrix that transforms the detection axis of the second sensor into the second axis, and the third correction matrix may be an inverse matrix of a rotation matrix that transforms the detection axis of the third sensor into the third axis.

(8) The above posture detection device may further include a signal selection section that sequentially selects one of the detection signals from the first sensor, the second sensor, and the third sensor in a predetermined cycle, and the A/D conversion section may include an A/D conversion circuit that sequentially A/D-converts the detection value selected by the signal selection section.

### BRIEF DESCRIPTION OF DRAWINGS

FIG. 1 is a diagram illustrating an example of the configuration of a posture detection device to which a correction parameter creation method according to one embodiment of the invention is applied.

FIG. 2 is a perspective view illustrating a posture detection device according to one embodiment of the invention.

FIG. 3 is a plan view illustrating an example of a vibrator included in an angular velocity sensor.

FIG. 4 is illustrates the operation of a vibrator included in an angular velocity sensor.

FIG. 5 is illustrates the operation of a vibrator included in an angular velocity sensor.

FIG. 6 is a diagram illustrating an example of the configuration of a driver circuit and a detection circuit included in an angular velocity sensor.

FIG. 7A is a diagram illustrating an installation angle error of a sensor.

FIG. 7B is a diagram illustrating an installation angle error of a sensor.

FIG. 7C is a diagram illustrating an installation angle error of a sensor.

FIG. 8 is a diagram illustrating the configuration of a correction parameter creation device according to one embodiment of the invention.

FIG. 9 is a flowchart illustrating an example of a correction parameter creation process according to one embodiment of the invention.

FIG. 10A is a diagram illustrating a correction parameter creation process according to one embodiment of the invention.

FIG. 10B is a diagram illustrating a correction parameter creation process according to one embodiment of the invention.

FIG. 10C is a diagram illustrating a correction parameter creation process according to one embodiment of the invention.

FIG. 11 is a diagram illustrating the configuration of a posture detection device according to one embodiment of the invention.

FIG. 12 is a diagram illustrating another configuration of a posture detection device according to one embodiment of the invention.

FIG. 13A is a diagram illustrating a related-art correction parameter creation method.

FIG. 13B is a diagram illustrating a related-art correction parameter creation method.

FIG. 13C is a diagram illustrating a related-art correction parameter creation method.

FIG. 14A is a diagram illustrating a related-art correction parameter creation method.

FIG. 14B is a diagram illustrating a related-art correction parameter creation method.

FIG. 14C is a diagram illustrating a related-art correction parameter creation method.

### DESCRIPTION OF EMBODIMENTS

Exemplary embodiments of the invention are described in detail below with reference to the drawings. Note that the following embodiments do not unduly limit the scope of the invention as stated in the claims. Note that all of the elements described below should not necessarily be taken as essential elements of the invention.

In the following embodiments, the first axis, the second axis, and the third axis respectively correspond to an X-axis, a Y-axis, and a Z-axis. Note that the first axis, the second axis, and the third axis may have an arbitrary relationship with the X-axis, the Y-axis, and the Z-axis.

### 1. Posture Detection Device

### 1-1. Configuration of Posture Detection Device

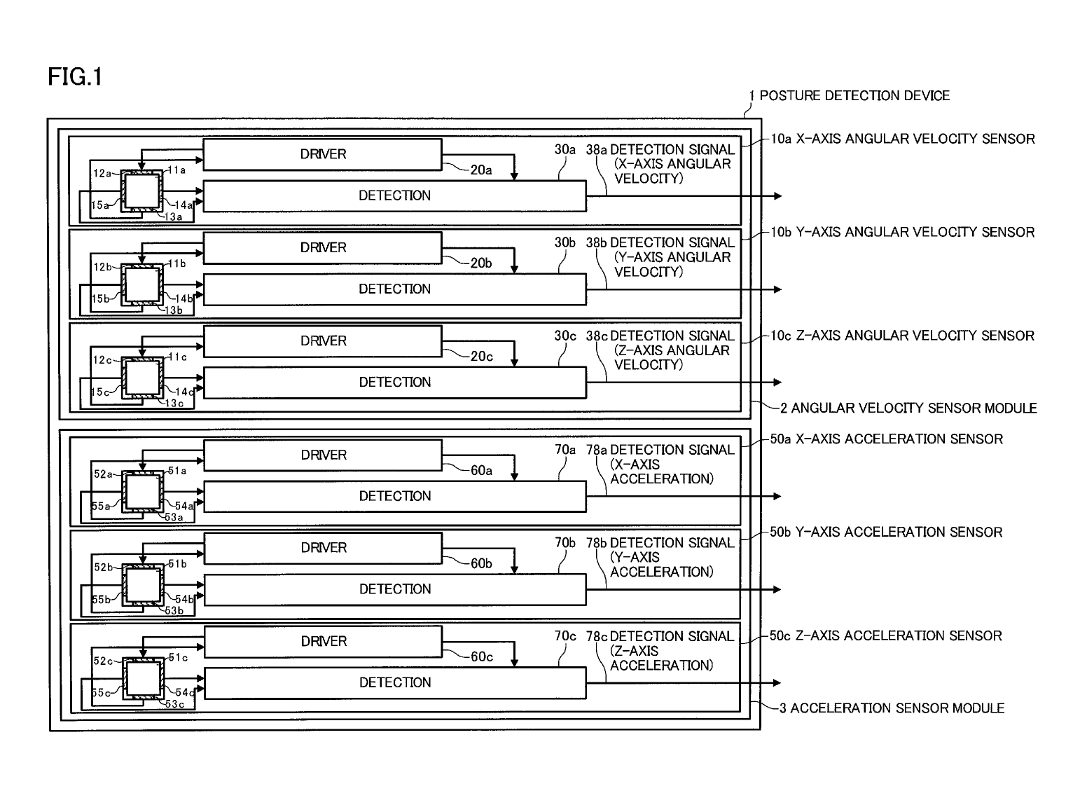

FIG. 1 is a diagram illustrating an example of the configuration of a posture detection device to which a correction parameter creation method according to one embodiment of the invention is applied.

As illustrated in FIG. 1, a posture detection device 1 according to one embodiment of the invention includes an angular velocity sensor module 2 that detects angular velocities around the X-axis, the Y-axis, and the Z-axis, and an acceleration sensor module 3 that detects accelerations in the X-axis direction, the Y-axis direction, and the Z-axis direction.

The angular velocity sensor module 2 includes an X-axis angular velocity sensor 10a that detects the angular velocity around the X-axis, a Y-axis angular velocity sensor 10b that detects the angular velocity around the Y-axis, and a Z-axis angular velocity sensor 10c that detects the angular velocity around the Z-axis.

The X-axis angular velocity sensor 10a includes a vibrator 11a, a driver circuit 20a that causes the vibrator 11a to vibrate, and a detection circuit 30a that generates an angular velocity detection signal 38a. Drive electrodes 12a and 13a of the vibrator 11a are connected to the driver circuit 20a, and detection electrodes 14a and 15a of the vibrator 11a are connected to the detection circuit 30a.

The Y-axis angular velocity sensor 10b includes a vibrator 11b, a driver circuit 20b that causes the vibrator 11b to vibrate, and a detection circuit 30b that generates an angular velocity detection signal 38b. Drive electrodes 12b and 13b of the vibrator 11b are connected to the driver circuit 20b, and detection electrodes 14b and 15b of the vibrator 11b are connected to the detection circuit 30b.

The Z-axis angular velocity sensor 10c includes a vibrator 11c, a driver circuit 20c that causes the vibrator 11c to vibrate, and a detection circuit 30c that generates an angular velocity detection signal 38c. Drive electrodes 12c and 13c of the vibrator 11c are connected to the driver circuit 20c, and detection electrodes 14c and 15c of the vibrator 11c are connected to the detection circuit 30c.

The acceleration sensor module 3 includes an X-axis acceleration sensor 50a that detects the acceleration in the X-axis direction, a Y-axis acceleration sensor 50b that detects the acceleration in the X-axis direction, and a Z-axis acceleration sensor 50c that detects the acceleration in the Z-axis direction.

The X-axis acceleration sensor 50a includes a vibrator 51a, a driver circuit 60a that causes the vibrator 51a to vibrate, and a detection circuit 70a that generates an acceleration detection signal 78a. Drive electrodes 52a and 53a of the vibrator 51a are connected to the driver circuit 60a, and detection electrodes 54a and 55a of the vibrator 51a are connected to the detection circuit 70a.

The Y-axis acceleration sensor 50b includes a vibrator 51b, a driver circuit 60b that causes the vibrator 51b to vibrate, and a detection circuit 70b that generates an acceleration detection signal 78b. Drive electrodes 52b and 53b of the vibrator 51b are connected to the driver circuit 60b, and detection electrodes 54b and 55b of the vibrator 51b are connected to the detection circuit 70b.

The Z-axis acceleration sensor 50c includes a vibrator 51c, a driver circuit 60c that causes the vibrator 51c to vibrate, and a detection circuit 70c that generates an acceleration detection signal 78c. Drive electrodes 52c and 53c of the vibrator 51c are connected to the driver circuit 60c, and detection electrodes 54c and 55c of the vibrator 51c are connected to the detection circuit 70c.

The angular velocity sensors 10a, 10b, and 10c respectively function as a first sensor, a second sensor, and a third sensor. The acceleration sensors 50a, 50b, and 50c respectively function as the first sensor, the second sensor, and the third sensor.

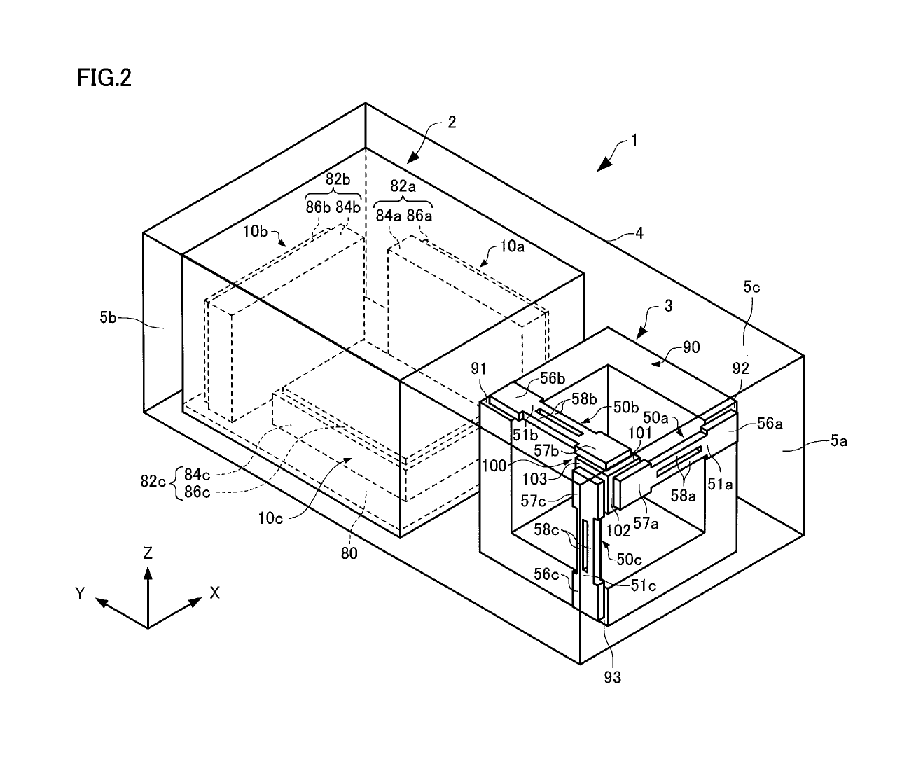

FIG. 2 is a perspective view illustrating the posture detection device according to one embodiment of the invention.

As illustrated in FIG. 2, the angular velocity sensor module 2 and the acceleration sensor module 3 included in the posture detection device 1 are formed in the shape of a cube (rectangular parallelepiped in a broad sense; hereinafter the same), and disposed in a package 4 formed in the shape of a rectangular parallelepiped.

The X-axis, the Y-axis, and the Z-axis are determined based on the posture detection device 1. For example, when the package 4 of the posture detection device 1 is formed in the shape of a rectangular parallelepiped, the X-axis, the Y-axis, and the Z-axis may be axes that perpendicularly intersect three orthogonal sides 5a, 5b, and 5c of the package 4. The positive direction of the X-axis, the Y-axis, and the Z-axis may be arbitrarily determined. In the following description, a direction indicated by an arrow in FIG. 2 is taken as the positive direction of each axis.

### 1-2. Angular Velocity Sensor Module

As illustrated in FIG. 2, the angular velocity sensor module 2 is configured so that the angular velocity sensors 10a, 10b, and 10c are mounted on an insulating substrate 80 such that their detection axes are almost parallel to the X-axis, the Y-axis, and the Z-axis, respectively. The vibrators 11a, 11b, and 11c are respectively disposed in packages 82a, 82b, and 82c. The packages 82a, 82b, and 82c are covered with a resin molding material.

The package 82a includes a package main body 84a and a lid 86a, the package 82b includes a package main body 84b and a lid 86b, and the package 82c includes a package main body 84c and a lid 86c. The package main bodies 84a, 84b, and 84c are formed in the shape of a rectangular parallelepiped by stacking and sintering a plurality of ceramic sheets. The lids 86a, 86b, and 86c are formed using a glass sheet, a metal sheet, a ceramic sheet, or the like. The upper opening of each of the package main bodies 84a, 84b, and 84c in which the vibrators 11a, 11b, and 11c are respectively disposed is respectively sealed with the lids 86a, 86b, and 86c via a bonding material (e.g., filler metal or low-melting-point glass). The vibrators 11a, 11b, and 11c are respectively connected to the driver circuits 20a, 20b, 20c and the detection circuits 30a, 30b, and 30c via a wiring pattern (not shown) formed on the insulating substrate 80.

The driver circuit 20a and the detection circuit 30a, the driver circuit 20b and the detection circuit 30b, and the driver circuit 20c and the detection circuit 30c may respectively be integrated in a chip, and disposed in the packages 82a, 82b, and 82c. Alternatively, the driver circuits 20a, 20b, and 20c and the detection circuits 30a, 30b, and 30c may all be integrated in a chip, and disposed on the insulating substrate 80.

Note that the detection signals 38a, 38b, and 38c from the detection circuits 30a, 30b, and 30c are output to the outside of the posture detection device 1 via external output terminals (not shown).

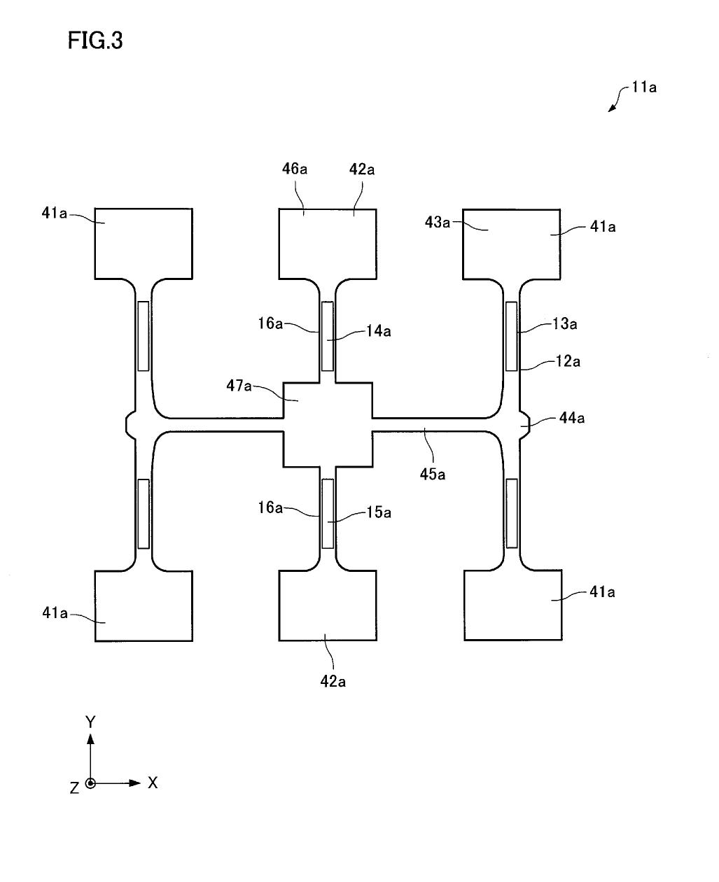

FIG. 3 is a plan view illustrating an example of the vibrator included in the angular velocity sensor. The vibrators 11a, 11b, and 11c respectively included in the angular velocity sensors 10a, 10b, and 10c have an identical configuration. FIG. 3 illustrates the configuration of the vibrator 11a. Note that the X-axis, the Y-axis, and the Z-axis in FIG. 3 indicate the axes of a quartz crystal independently of the X-axis, the Y-axis, and the Z-axis in FIG. 2.

The vibrator 11a is formed using a thin sheet of a piezoelectric material (e.g., quartz crystal). Drive vibrating arms 41a (drive vibrating elements in a broad sense) extend from a drive base 44a in the Y-axis direction. The drive electrodes 12a and 13a are respectively formed on the side surface and the upper surface of the drive vibrating arms 41a. The drive electrodes 12a and 13a are connected to the driver circuit 20a (see FIG. 1).

The drive base 44a is connected to a detection base 47a via a connection arm 45a that extends in the X-axis direction. Detection vibrating arms 42a (detection vibrating elements in a broad sense) extend from the detection base 47a in the Y-axis direction. The detection electrode 14a or 15a is formed on the upper surface of the detection vibrating arms 42a, and an electrode 16a is formed on the side surface of the detection vibrating arms 42a. The detection electrodes 14a and 15a are connected to the driver circuit 20a (see FIG. 1). The electrode 16a is grounded.

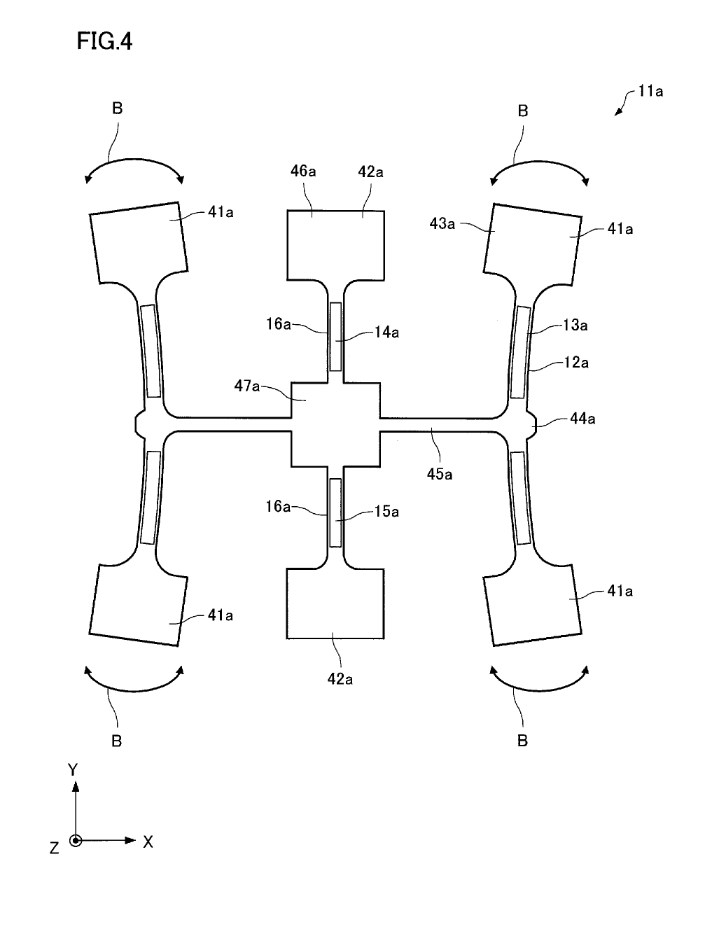

When a drive signal (alternating voltage/alternating current) is applied between the drive electrode 12a and the drive electrode 13a of the drive vibrating arms 41a, the drive vibrating arms 41a produce flexural vibrations due to a piezoelectric effect (see arrow B in FIG. 4).

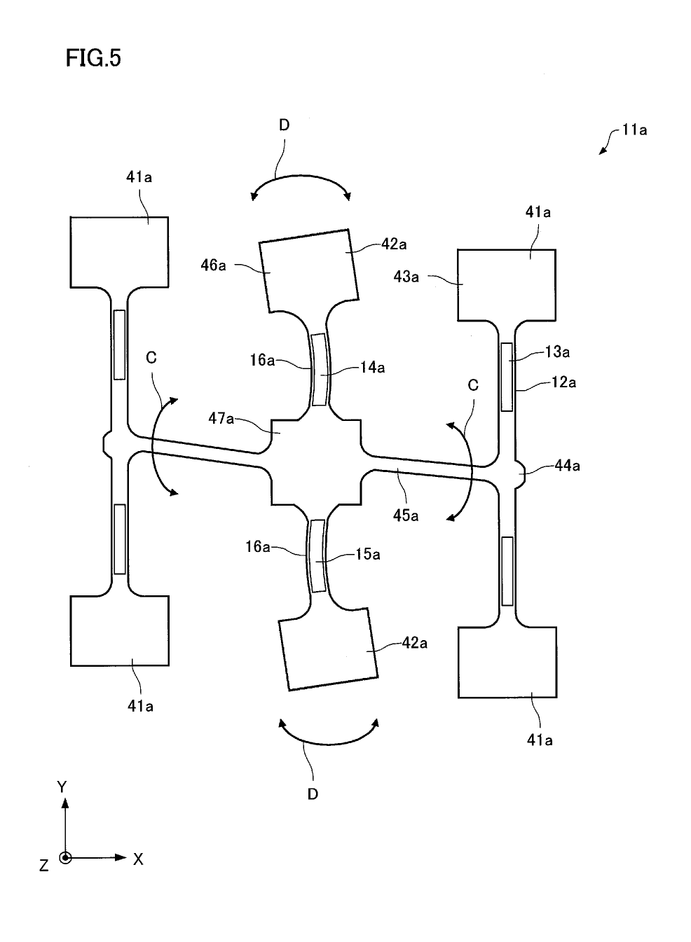

When the vibrator 11a has rotated around the Z-axis (see FIG. 5), the drive vibrating arms 41a are subjected to a Coriolis force in the direction perpendicular to the direction of the flexural vibrations (arrow B) and the Z-axis. As a result, the connection arms 45a vibrate as indicated by an arrow C. The detection vibrating arms 42a produce flexural vibrations (see arrow D) in synchronization with the vibrations (see arrow C) of the connection arms 45a.

An alternating voltage/alternating current is generated between the detection electrode 14a or 15a and the electrode 16a of the detection vibrating arms 42a in opposite directions due to an inverse piezoelectric effect based on the flexural vibrations. The vibrator 11a thus detects the angular velocity component based on the Coriolis force (detection axis: Z-axis), and outputs the detection signal via the detection electrodes 14a and 15a.

In the configuration illustrated in FIG. 3, the detection base 47a is disposed at the center of the vibrator 11a, and the detection vibrating arms 42a are disposed to extend from the detection base 47a in the +Y-axis direction and the −Y-axis direction in order to improve the balance of the vibrator 11a. The connection arms 45a are disposed to extend from the detection base 47a in the +X-axis direction and the −X-axis direction, and the drive vibrating arms 41a are disposed to extend from each connection arm 45a in the +Y-axis direction and the −Y-axis direction.

The end of the drive vibrating arm 41a forms a wide section 43a (i.e., weighted) so that the Coriolis force increases. The desired resonance frequency can be obtained using a short vibrating arm due to the weighting effect. The end of the detection vibrating arm 42a forms a wide section 46a (i.e., weighted) for the above reason.

Note that the configuration of the vibrator 11a is not limited to the above configuration insofar as the vibrator outputs the detection signal including the angular velocity component based on the Coriolis force. For example, the vibrator 11a may have a configuration in which the drive vibrating arm and the detection vibrating arm are formed by a single element, or may have a configuration in which a piezoelectric film is formed on the drive vibrating arm or the detection vibrating arm.

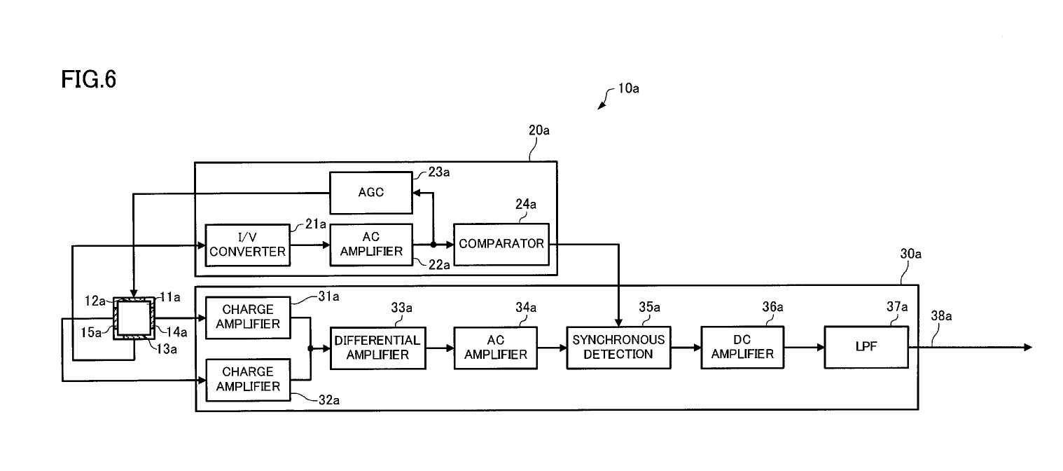

FIG. 6 is a diagram illustrating an example of the configuration of the driver circuit and the detection circuit included in the angular velocity sensor. The driver circuits 20a, 20b, 20c have an identical configuration, and the detection circuits 30a, 30b, and 30c have an identical configuration. FIG. 3 illustrates the configuration of the driver circuit 20a and the detection circuit 30a.

As illustrated in FIG. 6, the driver circuit 20a includes a current/voltage converter (I/V converter) 21a, an AC amplifier 22a, an automatic gain control circuit (AGC) 23a, and a comparator 24a.

When the vibrator 11a has vibrated, an alternating current based on the piezoelectric effect is output from the drive electrode 13a as a feedback signal, and input to the current/voltage converter (I/V converter) 21a. The current/voltage converter (I/V converter) 21a converts the alternating current into an alternating voltage signal having the same frequency as the oscillation frequency of the vibrator 11a, and outputs the alternating voltage signal.

The alternating voltage signal output from the current/voltage converter (I/V converter) 21a is input to the AC amplifier 22a. The AC amplifier 22a amplifies the alternating voltage signal, and outputs the amplified alternating voltage signal.

The alternating voltage signal output from the AC amplifier 22a is input to the automatic gain control circuit (AGC) 23a. The automatic gain control circuit (AGC) 23a controls the gain so that the alternating voltage signal has a constant amplitude, and outputs the resulting alternating voltage signal to the drive electrode 12a of the vibrator 11a. The vibrator 11a vibrates based on the alternating voltage signal input to the drive electrode 12a.

The alternating voltage signal amplified by the AC amplifier 22a is input to the comparator 24a. The comparator 24a outputs a square-wave voltage signal that is switched in output level based on the result of comparison between the alternating voltage signal and a reference voltage signal (reference voltage: amplitude center value of alternating voltage signal) to a synchronous detection circuit 35a of the detection circuit 30a.

As illustrated in FIG. 6, the detection circuit 30a includes charge amplifiers 31a and 32a, a differential amplifier 33a, an AC amplifier 34a, the synchronous detection circuit 35a, a DC amplifier 36a, and an integration circuit (LPF) 37a.

The reverse-phase detection signals (alternating currents) detected by the vibrator 11a are input to the charge amplifiers 31a and 32a via the detection electrodes 12a and 13a. Each of the charge amplifiers 31a and 32a converts the detection signal (alternating current) into an alternating voltage signal based on a reference voltage.

The differential amplifier 33a differentially amplifies the output signal from the charge amplifier 31a and the output signal from the charge amplifier 32a. The output signal from the differential amplifier 33a is amplified by the AC amplifier 34a.

The synchronous detection circuit 35a synchronously detects the output signal from the AC amplifier 34a based on the square-wave voltage signal output from the comparator 24a to extract the angular velocity component. The synchronous detection circuit 35a may be configured as a switch circuit that outputs the output signal from the AC amplifier 34a when the voltage level of the square-wave voltage signal is higher than that of the reference voltage, and reverses the output signal from the AC amplifier 34a based on the reference voltage, and outputs the resulting signal when the voltage level of the square-wave voltage signal is lower than that of the reference voltage, for example.

The angular velocity component signal extracted by the synchronous detection circuit 35a is amplified by the DC amplifier 36a, and input to the integration circuit (LPF) 37a.

The integration circuit (LPF) 37a generates an angular velocity detection signal 38a by attenuating a high-frequency component of the output signal from the DC amplifier 35a to extract a direct-current component, and outputs the angular velocity detection signal 38a to the outside.

### 1-3. Acceleration Sensor Module

As illustrated in FIG. 2, the acceleration sensor module 3 includes a base 90, a weight 100, and the acceleration sensors 50a, 50b, and 50c. Note that the driver circuits 60a, 60b, and 60c and the detection circuits 70a, 70b, and 70c illustrated in FIG. 1 are omitted in FIG. 2. The driver circuits 60a, 60b, and 60c and the detection circuits 70a, 70b, and 70c are disposed at an appropriate position inside the package 4. The detection signals 78a, 78b, and 78c from the detection circuit 70a, 70b, and 70c are output to the outside of the posture detection device 1 via external output terminals (not shown).

The base 90 is formed so that three square walls perpendicularly intersect to form a cubic shape, and includes mounting surfaces 91, 92, and 93 that perpendicularly intersect the X-axis direction, the Y-axis direction, and the Z-axis direction. The weight 100 is a cube having a predetermined mass, and includes bonding surfaces 101, 102, and 103 that perpendicularly intersect. The base 90 and the weight 100 are formed using an appropriate material (e.g., aluminum alloy).

The acceleration sensors 50a, 50b, and 50c respectively include the tuning-fork vibrators 51a, 51b, and 51c formed using a thin sheet of a piezoelectric material (e.g., quartz crystal).

The vibrators 51a, 51b, and 51c are configured so that base ends 56a, 56b, and 56c are respectively attached to the mounting surfaces 91, 92, and 93 of the base 90 such that their detection axes are almost parallel to the X-axis, the Y-axis, and the Z-axis, and are vertically supported by the walls of the base 90. Base ends 57a, 57b, and 57c of the vibrators 51a, 51b, and 51c are bonded to the bonding surfaces 101 to 103 of the weight 100 that respectively correspond to the mounting surfaces 91, 92, and 93. The weight 100 is thus supported by the vibrators 51a, 51b, and 51c in a suspended state in the X-axis direction, the Y-axis direction, and the Z-axis direction.

The drive electrodes 52a and 53a (not shown) are provided on the main surface and each side surface of two drive vibrating arms 58a of the vibrator 51a. When a predetermined alternating voltage is applied between the drive electrodes 52a and 53a by the driver circuit 60a, the drive vibrating arms 58a produce flexural vibrations at a predetermined frequency in opposite directions (i.e., the drive vibrating arms 58a move closer to each other or move away from each other).

When an external force has been applied to the acceleration sensor module 3 in a state in which the vibrator 51a vibrates at a predetermined frequency so that an acceleration in the X-axis direction has been applied to the weight 100, a compressive or tensile force is applied to the vibrator 51a in the longitudinal direction (X-axis direction) corresponding to the magnitude and the direction of the acceleration. The frequency of the vibrator 51a decreases when a compressive force is applied to the vibrator 51a, and increases when a tensile force is applied to the vibrator 51a. Therefore, the magnitude and the direction of the acceleration in the X-axis direction applied to the weight 100 can be calculated by detecting a change in frequency of the vibrator 51a using the detection circuit 70a, and calculating the load applied in the X-axis direction from the change in frequency.

The vibrators 51b and 51c are configured in the same manner as the vibrator 51a. The magnitude and the direction of the accelerations in the Y-axis direction and the Z-axis direction can be calculated in the same manner as described above.

Note that the driver circuits 60a, 60b, and 60c are configured in the same manner as the driver circuit 20a illustrated in FIG. 6, and the detection circuits 70a, 70b, and 70c can be configured in the same manner as a known circuit that detects a change in frequency. Therefore, description thereof is omitted.

### 2. Correction Parameter Creation Method

### 2-1. Installation Angle Error of Sensor

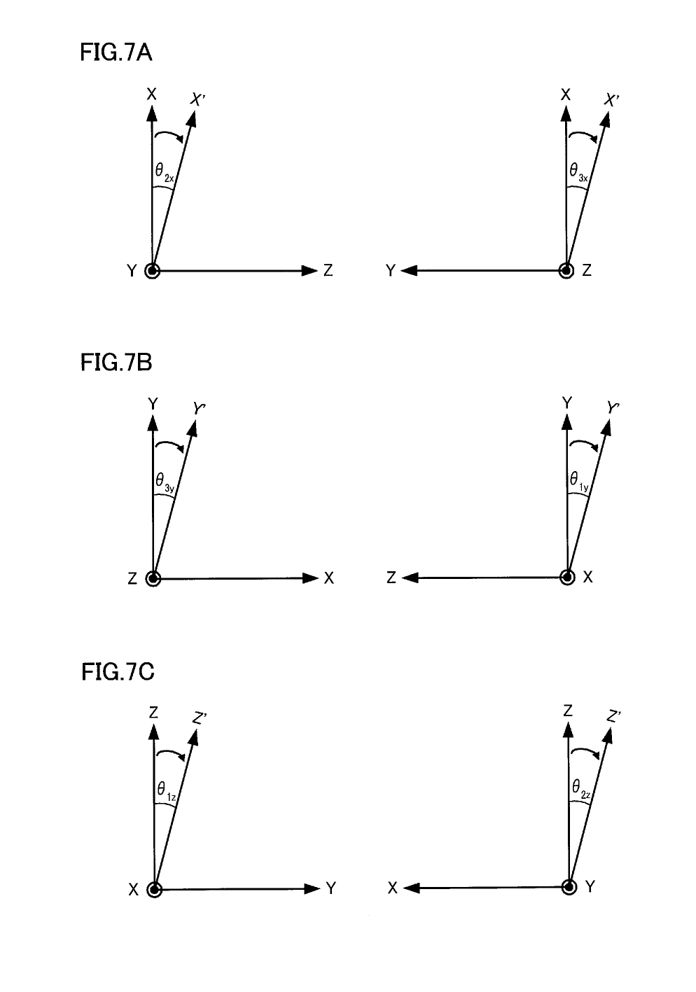

The angular velocity sensors 10a, 10b, and 10c are ideally installed so that their detection axes are accurately parallel to the X-axis, the Y-axis, and the Z-axis, respectively. Likewise, the acceleration sensors 50a, 50b, and 50c are ideally installed so that their detection axes are accurately parallel to the X-axis, the Y-axis, and the Z-axis, respectively. However, it is difficult to accurately install the angular velocity sensors 10a, 10b, and 10c and the acceleration sensors 50a, 50b, and 50c from the viewpoint of cost. As illustrated in FIG. 7A, the X-axis angular velocity sensor 10a is actually installed so that the detection axis is parallel to an X′-axis that is inclined at a small angle Δθ₂ₓ around the Y-axis and inclined at a small angle Δθ₃ₓ around the Z-axis. As illustrated in FIG. 7B, the Y-axis angular velocity sensor 10b is actually installed so that the detection axis is parallel to a Y′-axis that is inclined at a small angle Δθ_{3y} around the Z-axis and inclined at a small angle Δθ_{1y} around the X-axis. As illustrated in FIG. 7C, the Z-axis angular velocity sensor 10c is actually installed so that the detection axis is parallel to a Z′-axis that is inclined at a small angle Δθ_{1z} around the X-axis and inclined at a small angle Δθ_{2z} around the Y-axis. Specifically, an installation angle error around the Y-axis and an installation angle error around the Z-axis of the X-axis angular velocity sensor 10a are Δθ₂ₓ and Δθ₃ₓ, respectively, an installation angle error around the Z-axis and an installation angle error around the X-axis of the Y-axis angular velocity sensor 10b are Δθ_{3y} and Δθ_{1y}, respectively, and an installation angle error around the X-axis and an installation angle error around the Y-axis of the Z-axis angular velocity sensor 10c are Δθ_{3z} and Δθ_{1z}, respectively.

The acceleration sensors 50a, 50b, and 50c similarly have installation angle errors. Therefore, the detection value of each of the angular velocity sensors 10a, 10b, and 10c and the acceleration sensors 50a, 50b, and 50c differs from an ideal value.

### 2-2. Mathematical Consideration

The functional determinants (Jacobian) in the correction expressions (1) and (2) are not correction parameters that directly reflect the installation angle error of the sensor. When using the correction expressions (1) and (2), since the current detection value is estimated using the functional determinant (Jacobian) based on the preceding detection value, a corrected value is not obtained when the detection value is mapped. Therefore, an increase in correction accuracy is limited when using the correction expressions (1) and (2). Mathematical consideration of correction with higher accuracy is described below.

Rotation matrices T₁, T₂, and T₃ that respectively apply rotation at an angle θ around the X-axis, the Y-axis, and the Z-axis in a three-dimensional Euclidean space are expressed by the following expression (3).

$${T}_{1} ( θ ) = ( \begin{matrix}1 & 0 & 0 \\ 0 & cos θ & sin θ \\ 0 & - sin θ & cos θ\end{matrix} ) , {T}_{2} ( θ ) = ( \begin{matrix}cos θ & 0 & - sin θ \\ 0 & 1 & 0 \\ sin θ & 0 & cos θ\end{matrix} ) , \\ {T}_{3} ( θ ) = ( \begin{matrix}cos θ & sin θ & 0 \\ - sin θ & cos θ & 0 \\ 0 & 0 & 1\end{matrix} ) \qquad ( 3 )$$

An arbitrary rotation in the three-dimensional Euclidean space is expressed by a combination of the products of the rotation matrices T₁, T₂, and T₃. For example, a matrix T_{δ} that transforms the XYZ coordinate system into an X′ Y′Z′ coordinate system by rotating the XYZ coordinate system at an angle θ₃ around the Z-axis, rotating the XYZ coordinate system at an angle θ₂ around the Y-axis, and rotating the XYZ coordinate system at an angle θ₁ around the X-axis is expressed by the following expression (4). The matrix T_{δ} is hereinafter referred to as “transformation matrix”.

T_{δ}=T₁(θ₁)T₂(θ₂)T₃(θ₃) (4)

Suppose that the angular velocity sensors 10a, 10b, and 10c that have been installed so that their detection axes are parallel to the X-axis, the Y-axis, and the Z-axis, respectively, are actually installed so that their detection axes are parallel to the X′-axis, the Y′-axis, and the Z′-axis, respectively, due to an installation angle error. In this case, detection values Gₓ′, G_{y}′, and G_{z}′ of the angular velocity sensors 10a, 10b, and 10c and ideal values Gₓ, G_{y}, and G_{z} satisfy the following relational expression (5) based on the transformation matrix T_{δ}.

$$( \begin{matrix}{G}_{x}^{′} \\ {G}_{y}^{′} \\ {G}_{z}^{′}\end{matrix} ) = {T}_{δ} ( \begin{matrix}{G}_{x} \\ {G}_{y} \\ {G}_{z}\end{matrix} ) = {T}_{1} ( {θ}_{1} ) {T}_{2} ( {θ}_{2} ) {T}_{3} ( {θ}_{3} ) ( \begin{matrix}{G}_{x} \\ {G}_{y} \\ {G}_{z}\end{matrix} ) \qquad ( 5 )$$

Therefore, the ideal values Gₓ, G_{y}, and G_{z} can be calculated from the detection values Gₓ′, G_{y}′, and G_{z}′ of the angular velocity sensors 10a, 10b, and 10c using the following expression (6).

$$( \begin{matrix}{G}_{x} \\ {G}_{y} \\ {G}_{z}\end{matrix} ) = {T}_{δ}^{- 1} ( \begin{matrix}{G}_{x}^{′} \\ {G}_{y}^{′} \\ {G}_{z}^{′}\end{matrix} ) = {T}_{3}^{- 1} ( {θ}_{3} ) {T}_{2}^{- 1} ( {θ}_{2} ) {T}_{1}^{- 1} ( {θ}_{1} ) ( \begin{matrix}{G}_{x}^{′} \\ {G}_{y}^{′} \\ {G}_{z}^{′}\end{matrix} ) \qquad ( 6 )$$

Specifically, if the matrix T_{δ}⁻¹ can be obtained by some method, the detection values of the angular velocity sensors 10a, 10b, and 10c can be corrected to the ideal values using the expression (6). The matrix T_{δ}⁻¹ is hereinafter referred to as “correction matrix”.

When the installation angles of the angular velocity sensors 10a, 10b, and 10c can be optically measured, the installation angle errors θ₁, θ₂, and θ₃ are directly determined, and the rotation matrices T₁, T₂, and T₃ are calculated using the expression (3). The correction matrix T_{δ}⁻¹ can be obtained using the inverse matrices T₁⁻¹, T₂⁻¹, and T₃⁻¹.

When the installation angles of the angular velocity sensors 10a, 10b, and 10c cannot be optically measured, three input conditions are selected so that the installation angle errors around the X-axis, the Y-axis, and the Z-axis are reflected in the detection values (e.g., the angular velocity sensors 10a, 10b, and 10c are rotated around the X-axis, the Y-axis, and the Z-axis). The installation angle errors θ₁, θ₂, and θ₃ can be derived by solving three simultaneous equations obtained by substituting the detection value Gₓ′, G_{y}′, and G_{z}′ of the angular velocity sensors 10a, 10b, and 10c under the input conditions and the ideal values Gₓ, G_{y}, and G_{z} into the expression (6). However, since these simultaneous equations are very complicated, the installation angle errors θ₁, θ₂, and θ₃ cannot be easily derived.

If the installation angle error θ is a very small value, the following expression (7) is satisfied.

sin Δθ≅θ, cos Δθ≅θ, 1±Δθ²≅1 (7)

Therefore, when the installation angle errors θ₁, θ₂, and θ₃ are very small values, the transformation matrix T_{δ} is given by the following expression (8).

$${T}_{δ} ≡ {T}_{1} ( Δ {θ}_{1} ) {T}_{2} ( Δ {θ}_{2} ) {T}_{3} ( Δ {θ}_{3} ) ≡ ( \begin{matrix}1 & Δ {θ}_{3} & - Δ {θ}_{2} \\ –Δ {θ}_{3} & 1 & Δ {θ}_{1} \\ Δ {θ}_{2} & - Δ {θ}_{1} & 1\end{matrix} ) \qquad ( 8 )$$

Therefore, the transformation matrix T_{δ} can be expressed by the linear sum of matrices J₁, J₂, and J₃ (bases) (see the following expression (9)).

$${T}_{δ} = I + {\sum }_{i = 1}^{3} {J}_{i} Δ {θ}_{i} \\ {J}_{1} = ( \begin{matrix}0 & 0 & 0 \\ 0 & 0 & 1 \\ 0 & - 1 & 0\end{matrix} ) , {J}_{2} = ( \begin{matrix}0 & 0 & - 1 \\ 0 & 0 & 0 \\ 1 & 0 & 0\end{matrix} ) , {J}_{3} = ( \begin{matrix}0 & 1 & 0 \\ - 1 & 0 & 0 \\ 0 & 0 & 0\end{matrix} ) \qquad ( 9 )$$

The X-axis angular velocity sensor 10a is installed so that the detection axis is parallel to the X′-axis that is rotated at a small angle Δθ₂ₓ around the Y-axis and rotated at a small angle Δθ₃ₓ around the Z-axis. Since the installation angle error Δθ₁ₓ around the X-axis is 0, a transformation matrix T_{δx} is given by the following expression (10) based on the expression (9).

$${T}_{δ x} = I + {J}_{2} Δ {θ}_{2 x} + {J}_{3} Δ {θ}_{3 x} = ( \begin{matrix}1 & Δ {θ}_{3 x} & - Δ {θ}_{2 x} \\ - Δ {θ}_{3 x} & 1 & 0 \\ Δ {θ}_{2 x} & 0 & 1\end{matrix} ) \qquad ( 10 )$$

The Y-axis angular velocity sensor 10b is installed so that the detection axis is parallel to the Y′-axis that is rotated at a small angle Δθ_{1y} around the X-axis and rotated at a small angle Δθ_{3y} around the Z-axis. Since the installation angle error Δθ_{2y} around the Y-axis is 0, a transformation matrix T_{δy} is given by the following expression (11) based on the expression (9).

$${T}_{δ y} = I + {J}_{1} Δ {θ}_{1 y} + {J}_{3} Δ {θ}_{3 y} = ( \begin{matrix}1 & {Δθ}_{3 y} & 0 \\ - {Δθ}_{3 y} & 1 & {Δθ}_{1 y} \\ 0 & - {Δθ}_{1 y} & 1\end{matrix} ) \qquad ( 11 )$$

The Z-axis angular velocity sensor 10c is actually installed so that the detection axis is parallel to the Z′-axis that is rotated at a small angle Δθ_{1z} around the X-axis and rotated at a small angle Δθ_{2z} around the Y-axis. Since the installation angle error Δθ_{3z} around the Z-axis is 0, a transformation matrix T_{δz} is given by the following expression (12) based on the expression (9).

$${T}_{δ z} = I + {J}_{1} {Δθ}_{1 x} + {J}_{2} {Δθ}_{2 x} = ( \begin{matrix}1 & 0 & - Δ {θ}_{2 z} \\ 0 & 1 & {Δθ}_{1 z} \\ {Δθ}_{2 z} & - {Δθ}_{1 z} & 1\end{matrix} ) \qquad ( 12 )$$

According to the expressions (10), (11), and (12), if the installation angle errors Δθ₂ₓ, Δθ₃ₓ, Δθ_{1y}, Δθ_{3y}, Δθ_{1z}, and Δθ_{2z} can be obtained by some method, the transformation matrices T_{δx}, T_{δy}, and T_{δz} can be calculated. Correction matrices T_{δx}⁻¹, T_{δy}⁻¹, and T_{δz}⁻¹ can be obtained by calculating the inverse matrices of the transformation matrices T_{δx}, T_{δy}, and T_{δz}. Therefore, the detection values Gₓ′, G_{y}′, and G_{z}′ of the angular velocity sensors 10a, 10b, and 10c can be corrected to the ideal values Gₓ, G_{y}, and G_{z} using the following expression (13).

$$( \begin{matrix}{G}_{x} \\ {G}_{y} \\ {G}_{z}\end{matrix} ) = {T}_{δ x}^{- 1} ( \begin{matrix}{G}_{x}^{′} \\ 0 \\ 0\end{matrix} ) + {T}_{δ y}^{- 1} ( \begin{matrix}0 \\ {G}_{y}^{′} \\ 0\end{matrix} ) + {T}_{δ z}^{- 1} ( \begin{matrix}0 \\ 0 \\ {G}_{z}^{′}\end{matrix} ) \qquad ( 13 )$$

The correction matrices T_{δx}⁻¹, T_{δy}⁻¹, and T_{δz}⁻¹ in the correction expression (13) directly reflect the installation angle errors Δθ₂ₓ, Δθ₃ₓ, Δθ_{1y}, Δθ_{3y}, Δθ_{1z}, and Δθ_{2z} of the angular velocity sensors 10a, 10b, and 10c. According to the correction expression (13), when the current detection values Gₓ′, G_{y}′, and G_{z}′ have been obtained, the corrected values (ideal values) Gx, Gy, and Gz can be calculated without using the preceding detection values. Therefore, an increase in correction accuracy and an increase in correction calculation speed can be implemented using the correction expression (13).

Note that the correction matrices T_{δx}⁻¹, T_{δy}⁻¹, and T_{δz}⁻¹ respectively correspond to the first correction matrix, the second correction matrix, and the third correction matrix.

The installation angle errors Δθ₂ₓ, Δθ₃ₓ, Δθ_{1y}, Δθ_{3y}, Δθ_{1z}, and Δθ_{2z} are obtained by the following method.

When a detection value that indicates that the X-axis angular velocity sensor 10a has been rotated at an angle Δθ_{xx′} around the X′-axis, rotated at an angle Δθ_{xy′} around the Y′-axis, and rotated at an angle Δθ_{xy′} around the Z′-axis is obtained when the X-axis angular velocity sensor 10a has been rotated at an angle Δθₓₓ around the X-axis, rotated at an angle Δθ_{xy} around the Y-axis, and rotated at an angle Δθ_{xz} around the Z-axis, the following expression (14) is satisfied based on the expression (10).

$${T}_{δ x} ( \begin{matrix}{Δθ}_{xx} \\ {Δθ}_{xy} \\ {Δθ}_{xz}\end{matrix} ) = ( \begin{matrix}{Δθ}_{xx} + {Δθ}_{3 x} {Δθ}_{xy} - {Δθ}_{2 x} {Δθ}_{xz} \\ {Δθ}_{xy} - {Δθ}_{3 x} {Δθ}_{xx} \\ {Δθ}_{xz} + {Δθ}_{2 x} {Δθ}_{xx}\end{matrix} ) = ( \begin{matrix}{Δθ}_{{xx}^{′}} \\ {Δθ}_{{xy}^{′}} \\ {Δθ}_{{xz}^{′}}\end{matrix} ) \qquad ( 14 )$$

When a detection value that indicates that the Y-axis angular velocity sensor 10b has been rotated at an angle Δθ_{yx′} around the X′-axis, rotated at an angle Δθ_{yy′} around the Y′-axis, and rotated at an angle Δθ_{yz′} around the Z′-axis is obtained when the Y-axis angular velocity sensor 10b has been rotated at an angle Δθ_{yx} around the X-axis, rotated at an angle Δθ_{yy} around the Y-axis, and rotated at an angle Δθ_{yz} around the Z-axis, the following expression (15) is satisfied based on the expression (11).

$${T}_{δ y} ( \begin{matrix}{Δθ}_{yx} \\ {Δθ}_{yy} \\ {Δθ}_{yz}\end{matrix} ) = ( \begin{matrix}{Δθ}_{yx} + {Δθ}_{3 y} {Δθ}_{yy} \\ {Δθ}_{yy} - {Δθ}_{3 y} {Δθ}_{yx} + {Δθ}_{1 y} {Δθ}_{yz} \\ {Δθ}_{yz} - {Δθ}_{1 y} {Δθ}_{yy}\end{matrix} ) = ( \begin{matrix}{Δθ}_{{yx}^{′}} \\ {Δθ}_{{yy}^{′}} \\ {Δθ}_{{yz}^{′}}\end{matrix} ) \qquad ( 15 )$$

When a detection value that indicates that the Z-axis angular velocity sensor 10c has been rotated at an angle Δθ_{zx′} around the X′-axis, rotated at an angle Δθ_{zy′} around the Y′-axis, and rotated at an angle Δθ_{zz′} around the Z′-axis is obtained when the Z-axis angular velocity sensor 10c has been rotated at an angle Δθ_{zx} around the X-axis, rotated at an angle Δθ_{zy} around the Y-axis, and rotated at an angle Δθ_{zz} around the Z-axis, the following expression (16) is satisfied based on the expression (12).

$${T}_{δ z} ( \begin{matrix}{Δθ}_{zx} \\ {Δθ}_{zy} \\ {Δθ}_{zz}\end{matrix} ) = ( \begin{matrix}{Δθ}_{zx} - {Δθ}_{2 z} {Δθ}_{zz} \\ {Δθ}_{zy} + {Δθ}_{1 z} {Δθ}_{zz} \\ {Δθ}_{zz} - {Δθ}_{2 z} {Δθ}_{zx} - {Δθ}_{1 z} {Δθ}_{zy}\end{matrix} ) = ( \begin{matrix}{Δθ}_{{zx}^{′}} \\ {Δθ}_{{zy}^{′}} \\ {Δθ}_{{zz}^{′}}\end{matrix} ) \qquad ( 16 )$$

When rotating the posture detection device 1 at an angle Δθₓ around the X-axis without rotating the posture detection device 1 around the Y-axis and the Z-axis, since Δθ_{yx}=Δθₓ, Δθ_{yy}=0, and Δθ_{yz}=0 in the expression (15), then Δθ_{yx′}=Δθₓ, Δθ_{yz′}=0, and the following relational expression (17) is obtained.

Δθ_{yy′}=−Δθ_{3y}Δθₓ (17)

Since the angle Δθ_{yy′} can be obtained by multiplying the detection value of the Y-axis angular velocity sensor 10b (angular velocity around the Y′-axis) by a predetermined time, the angle Δθ_{3y} can be obtained by substituting the angles Δθ_{yy′} and Δθₓ into the expression (17).

Likewise, since Δθ_{zx}=Δθₓ, Δθ_{zy}=0, and Δθ_{zz}=0 in the expression (16), then Δθ_{zx′}=Δθₓ, Δθ_{zy′}=0, and the following relational expression (18) is obtained.

Δθ_{zz′}=Δθ_{2z}Δθₓ (18)

Since the angle Δθ_{zz′} can be obtained by multiplying the detection value of the Z-axis angular velocity sensor 10c (angular velocity around the Z′-axis) by a predetermined time, the angle Δθ_{2z} can be obtained by substituting the angles Δθ_{zz′} and Δθₓ into the expression (18).

When rotating the posture detection device 1 at an angle Δθ_{y} around the Y-axis without rotating the posture detection device 1 around the X-axis and the Z-axis, since Δθₓₓ=0, Δθ_{xy}=Δθ_{y}, and Δθ_{xz}=0 in the expression (14), then Δθ_{xy′}=Δθ_{y}, Δθ_{xz′}=0, and the following relational expression (19) is obtained.

Δθ_{xx′}=Δθ₃ₓΔθ_{y} (19)

Since the angle Δθ_{xx′} can be obtained by multiplying the detection value of the X-axis angular velocity sensor 10a (angular velocity around the X′-axis) by a predetermined time, the angle Δθ₃ₓ can be obtained by substituting the angles Δθ_{xx′} and Δθ_{y} into the expression (19).

Likewise, since Δθ_{zx}=0, Δθ_{zy}=Δθ_{y}, and Δθ_{zz}=0 in the expression (16), then Δθ_{zx′}=0, Δθ_{zy′}=Δθ_{y}, and the following relational expression (20) is obtained.

Δθ_{zz′}=−Δθ_{1z}Δθ_{y} (20)

Since the angle Δθ_{zz′} can be obtained by multiplying the detection value of the Z-axis angular velocity sensor 10c (angular velocity around the Z′-axis) by a predetermined time, the angle Δθ_{1z} can be obtained by substituting the angles Δθ_{zz′} and Δθ_{y} into the expression (20).

When rotating the posture detection device 1 at an angle Δθ_{z} around the Z-axis without rotating the posture detection device 1 around the X-axis and the Y-axis, since Δθₓₓ=0, Δθ_{xy}=0, and Δθ_{xz}=Δθ_{z} in the expression (14), then Δθ_{xy′}=0, Δθ_{xz′}=Δθ_{z}, and the following relational expression (21) is obtained.

Δθ_{xx′}=−Δθ₂ₓΔθ_{z} (21)

Since the angle Δθ_{xx′} can be obtained by multiplying the detection value of the X-axis angular velocity sensor 10a (angular velocity around the X′-axis) by a predetermined time, the angle Δθ₂ₓ can be obtained by substituting the angles Δθ_{xx′} and Δθ_{z} into the expression (21).

Likewise, since Δθ_{yx}=0, Δθ_{yy}=0, and Δθ_{yz}=Δθ_{z} in the expression (15), then Δθ_{yx′}=0, Δθ_{yz′}=Δθ_{z}, and the following relational expression (22) is obtained.

Δθ_{yy′}=Δθ_{1y}Δθ_{z} (22)

Since the angle Δθ_{yy′} can be obtained by multiplying the detection value of the Y-axis angular velocity sensor 10b (angular velocity around the Y′-axis) by a predetermined time, the angle Δθ_{1y} can be obtained by substituting the angles Δθ_{yy′} and Δθ_{z} into the expression (22).

The detection values Gₓ′, G_{y}′, and G_{z}′ of the angular velocity sensors 10a, 10b, and 10c can be corrected to the ideal values Gₓ, G_{y}, and G_{z} by substituting the inverse matrices T_{δx}⁻¹, T_{δy}⁻¹, and T_{δz}⁻¹ calculated from the angles Δθ₂ₓ, Δθ₃ₓ, Δθ_{1y}, Δθ_{3y}, Δθ_{1z}, and Δθ_{2z} into the expression (13).

The correction calculations indicated by the expression (13) are performed by a CPU or a dedicated circuit using a digital value. Therefore, the small rotation angles Δθ_{x′}, Δθ_{y′}, and Δθ_{z′} around the X′-axis, the Y′-axis, and the Z′-axis obtained by multiplying the A/D-converted values of the detection values Gₓ′, G_{y}′, and G_{z}′ of the angular velocity sensors 10a, 10b, and 10c by an A/D conversion sampling cycle Δt are corrected to the small rotation angles Δθₓ, Δθ_{y}, and Δθ_{z} around the X-axis, the Y-axis, and the Z-axis using the following expression (23).

$$( \begin{matrix}{Δθ}_{x} \\ {Δθ}_{y} \\ {Δθ}_{z}\end{matrix} ) = {T}_{δ x}^{- 1} ( \begin{matrix}{Δθ}_{{x}^{′}} \\ 0 \\ 0\end{matrix} ) + {T}_{δ y}^{- 1} ( \begin{matrix}0 \\ {Δθ}_{{y}^{′}} \\ 0\end{matrix} ) + {T}_{δz}^{- 1} ( \begin{matrix}0 \\ 0 \\ {Δθ}_{{z}^{′}}\end{matrix} ) \qquad ( 23 )$$

The above theory can be similarly applied to correction of the detection values of the X-axis acceleration sensor 50a, the Y-axis acceleration sensor 50b, and the Z-axis acceleration sensor 50c.

The X-axis acceleration sensor 50a is installed so that the detection axis is parallel to the X′-axis that is rotated at a small angle Δφ₂ₓ around the Y-axis and rotated at a small angle Δφ₃ₓ around the Z-axis (the angles Δφ₂ₓ and Δφ₃ₓ are installation angle errors). A transformation matrix T_{γx} is given by the following expression (24).

$${T}_{γ x} = I + {J}_{2} {Δφ}_{2 x} + {J}_{3} {Δφ}_{3 x} = ( \begin{matrix}1 & {Δφ}_{3 x} & - {Δφ}_{2 x} \\ - {Δφ}_{3 x} & 1 & 0 \\ {Δφ}_{2 x} & 0 & 1\end{matrix} ) \qquad ( 24 )$$

The Y-axis acceleration sensor 50b is installed so that the detection axis is parallel to the Y′-axis that is rotated at a small angle Δφ_{1y} around the X-axis and rotated at a small angle Δφ_{3y} around the Z-axis (the angles Δφ_{1y} and Δφ_{3y} are installation angle errors). A transformation matrix T_{γy} is given by the following expression (25).

$${T}_{γ y} = I + {J}_{1} {Δφ}_{1 y} + {J}_{3} {Δφ}_{3 y} = ( \begin{matrix}1 & {Δφ}_{3 y} & 0 \\ - {Δφ}_{3 y} & 1 & {Δφ}_{1 y} \\ 0 & - {Δφ}_{1 y} & 1\end{matrix} ) \qquad ( 25 )$$

The Z-axis acceleration sensor 50c is installed so that the detection axis is parallel to the Z′-axis that is rotated at a small angle Δφ_{1z} around the X-axis and rotated at a small angle Δφ_{2z} around the Y-axis (the angles Δφ_{1z} and Δφ_{2z} are installation angle errors). A transformation matrix T_{γz} is given by the following expression (26).

$${T}_{γ z} = I + {J}_{1} {Δφ}_{1 x} + {J}_{2} {Δφ}_{2 x} = ( \begin{matrix}1 & 0 & - {Δφ}_{2 z} \\ 0 & 1 & {Δφ}_{1 z} \\ {Δφ}_{2 z} & - {Δφ}_{1 z} & 1\end{matrix} ) \qquad ( 26 )$$

The expressions (24) to (26) correspond to the expressions (10) to (12) for the angular velocity sensors 10a, 10b, and 10c.

When a detection value that indicates that the X-axis acceleration sensor 50a has been moved at a velocity Δv_{xx′} in the X′-axis direction, moved at a velocity Δv_{xy′} in the Y′-axis direction, and moved at a velocity Δv_{xz′} in the Z′-axis direction is obtained when the X-axis acceleration sensor 50a has been moved at a velocity Δvₓₓ in the X-axis direction, moved at a velocity Δv_{xy} in the Y-axis direction, and moved at a velocity Δv_{xz} in the Z-axis direction, the following expression (27) is satisfied.

$${T}_{γ x} ( \begin{matrix}Δ {v}_{xx} \\ Δ {v}_{xy} \\ Δ {v}_{xz}\end{matrix} ) = ( \begin{matrix}Δ {v}_{xx} + {Δφ}_{3 x} Δ {v}_{xy} - {Δφ}_{2 x} Δ {v}_{xz} \\ Δ {v}_{xy} - {Δφ}_{3 x} Δ {v}_{xx} \\ Δ {v}_{xz} + {Δφ}_{2 x} Δ {v}_{xx}\end{matrix} ) = ( \begin{matrix}Δ {v}_{{xx}^{′}} \\ Δ {v}_{{xy}^{′}} \\ Δ {v}_{{xz}^{′}}\end{matrix} ) \qquad ( 27 )$$

When a detection value that indicates that the Y-axis acceleration sensor 50b has been moved at a velocity Δv_{yx′} in the X′-axis direction, moved at a velocity Δv_{yy′} in the Y′-axis direction, and moved at a velocity Δv_{yz′} in the Z′-axis direction is obtained when the Y-axis acceleration sensor 50b has been moved at a velocity Δv_{yx} in the X-axis direction, moved at a velocity Δv_{yy} in the Y-axis direction, and moved at a velocity Δv_{yz} in the Z-axis direction, the following expression (28) is satisfied.

$${T}_{γ y} ( \begin{matrix}Δ {v}_{yx} \\ Δ {v}_{yy} \\ Δ {v}_{yz}\end{matrix} ) = ( \begin{matrix}Δ {v}_{yx} + {Δφ}_{3 y} Δ {v}_{yy} \\ Δ {v}_{yy} - {Δφ}_{3 y} Δ {v}_{yx} + {Δφ}_{1 y} Δ {v}_{yz} \\ Δ {v}_{yz} - {Δφ}_{1 y} Δ {v}_{yy}\end{matrix} ) = ( \begin{matrix}Δ {v}_{{yx}^{′}} \\ Δ {v}_{{yy}^{′}} \\ Δ {v}_{{yz}^{′}}\end{matrix} ) \qquad ( 28 )$$

When a detection value that indicates that the Z-axis acceleration sensor 50c has been moved at a velocity Δv_{zx′} in the X′-axis direction, moved at a velocity Δv_{zy′} in the Y′-axis direction, and moved at a velocity Δv_{zz′} in the Z′-axis direction is obtained when the Z-axis acceleration sensor 50c has been moved at a velocity Δv_{zx} in the X-axis direction, moved at a velocity Δv_{zy} in the Y-axis direction, and moved at a velocity Δv_{zz} in the Z-axis direction, the following expression (29) is satisfied.

$${T}_{γ z} ( \begin{matrix}Δ {v}_{zx} \\ Δ {v}_{zy} \\ Δ {v}_{zz}\end{matrix} ) = ( \begin{matrix}Δ {v}_{zx} - {Δφ}_{2 z} Δ {v}_{zz} \\ Δ {v}_{zy} + {Δφ}_{1 z} Δ {v}_{zz} \\ Δ {v}_{zz} + {Δφ}_{2 z} Δ {v}_{zx} - {Δφ}_{1 z} Δ {v}_{zy}\end{matrix} ) = ( \begin{matrix}Δ {v}_{{zx}^{′}} \\ Δ {v}_{{zy}^{′}} \\ Δ {v}_{{zz}^{′}}\end{matrix} ) \qquad ( 29 )$$

The expressions (27) to (29) correspond to the expressions (14) to (16) for the angular velocity sensors 10a, 10b, and 10c. The following expressions (30) to (35) are obtained in the same manner as in the case of deriving the expressions (17) to (22) of the angular velocity sensors 10a, 10b, and 10c.

Δv_{yy′}=−Δφ_{3y}Δvₓ (30)

Δv_{zz′}=Δφ_{2z}Δvₓ (31)

Δv_{xx′}=Δφ₃ₓΔv_{y} (32)

Δv_{zz′}=−Δφ_{1z}Δv_{y} (33)

Δv_{xx′}=−Δφ₂ₓΔv_{z} (34)

Δv_{yy′}=Δφ_{1y}Δv_{z} (35)

The detection values Aₓ′, A_{y}′, and A_{z}′ of the acceleration sensors 50a, 50b, and 50c can be corrected to the ideal values Aₓ, A_{y}, and A_{z} by substituting the inverse matrices T_{γx}⁻¹, T_{γy}⁻¹, and T_{γz}⁻¹ calculated from the angles Δφ₂ₓ, Δφ₃ₓ, Δφ_{1y}, Δφ_{3y}, Δφ_{1z}, and Δφ_{2z} into the following expression (36). The expression (36) corresponds to the expression (13) for the angular velocity sensors 10a, 10b, and 10c.

$$( \begin{matrix}{A}_{x} \\ {A}_{y} \\ {A}_{z}\end{matrix} ) = {T}_{γ x}^{- 1} ( \begin{matrix}{A}_{x}^{′} \\ 0 \\ 0\end{matrix} ) + {T}_{γ y}^{- 1} ( \begin{matrix}0 \\ {A}_{y}^{′} \\ 0\end{matrix} ) + {T}_{γ z}^{- 1} ( \begin{matrix}0 \\ 0 \\ {A}_{z}^{′}\end{matrix} ) \qquad ( 36 )$$

The correction calculations indicated by the expression (36) are performed by a CPU or a dedicated circuit using a digital value. Therefore, the small velocities Δv_{x′}, Δv_{y′}, and Δv_{z′} in the X′-axis direction, the Y′-axis direction, and the Z′-axis direction obtained by multiplying the A/D-converted values of the detection values Aₓ′, A_{y}′, and A_{z}′ of the acceleration sensors 50a, 50b, and 50c by the A/D conversion sampling cycle Δt are corrected to the small velocities Δvₓ, Δv_{y}, and Δv_{z} in the X-axis direction, the Y-axis direction, and the Z-axis direction using the following expression (37).

$$( \begin{matrix}Δ {v}_{x} \\ Δ {v}_{y} \\ Δ {v}_{z}\end{matrix} ) = {T}_{γ x}^{- 1} ( \begin{matrix}Δ {v}_{{x}^{′}} \\ 0 \\ 0\end{matrix} ) + {T}_{γ y}^{- 1} ( \begin{matrix}0 \\ Δ {v}_{{y}^{′}} \\ 0\end{matrix} ) + {T}_{γ z}^{- 1} ( \begin{matrix}0 \\ 0 \\ Δ {v}_{{z}^{′}}\end{matrix} ) \qquad ( 37 )$$

### 2-3. Correction Parameter Creation Device

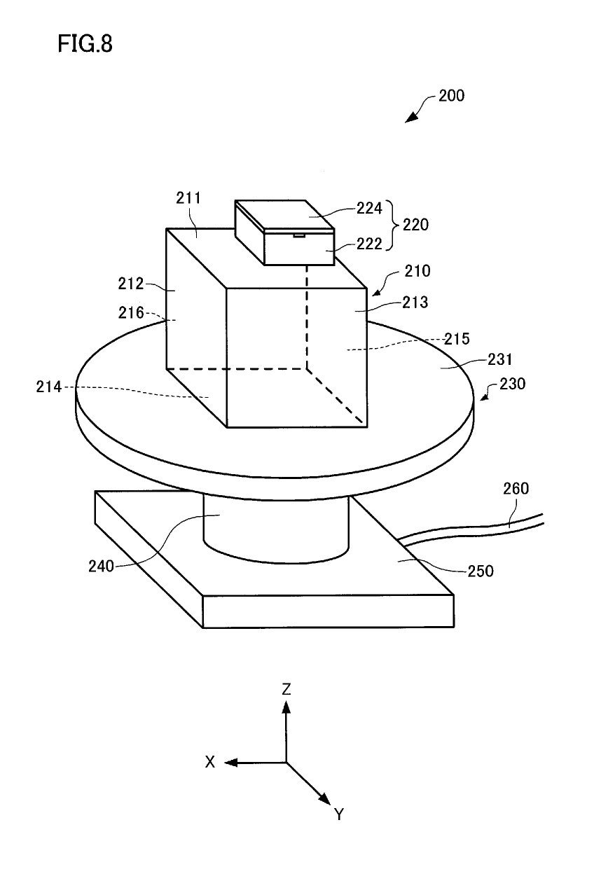

FIG. 8 is a diagram illustrating the configuration of a correction parameter creation device according to one embodiment of the invention.

A correction parameter creation device 200 illustrated in FIG. 8 is used to create a correction parameter (correction matrix) for correcting the detection value of each sensor of the posture detection device 1 including an error due to an installation angle error to an ideal value.

The correction parameter creation device 200 includes a cubic jig 210, a socket 220, a turntable 230, a rotary motor 240, a support stage 250, a cable 260, and the like.

The cubic jig 210 is formed in the shape of a cube (may be a rectangular parallelepiped) using a metal material or the like. The cubic jig 210 is formed so that three sides 211, 212, and 213 perpendicularly intersect. The socket 220 is secured on the side 211. The sides 211, 212, and 213 of the cubic jig 210 respectively correspond to the first side, the second side, and the third side of the jig.

The socket 220 includes a socket main body 222 and a lid 224 that can be opened and closed. The socket main body 220 can closely receive the posture detection device 1 in a predetermined direction.

The cubic jig 210 can secure the posture detection device 1 placed in the socket 220 so that the X-axis, the Y-axis, and the Z-axis of the posture detection device 1 perpendicularly intersect the sides 212, 213, and 211, respectively. An anchorage (not shown) is secured on sides 214, 215, and 216 of the cubic jig 210 that are respectively opposite to the sides 211, 212, and 213.

An upper side 231 of the turntable 230 has vanishingly small elevations and depressions. An anchorage (not shown) is secured on the upper side 231. One of the sides 214, 215, and 216 of the cubic jig 210 can be secured on the upper side 231 by connecting the anchorage of the cubic jig 210 to the anchorage of the turntable 230.

The tilt of the turntable 230 can be adjusted. The tilt of the turntable 230 is accurately adjusted so that the upper side 231 of the turntable 230 is horizontal in a state in which the correction parameter creation device 200 is installed.

The rotary motor 240 is secured on the support stage 250. The rotary motor 240 can rotate clockwise or counterclockwise around a vertical axis at an angular velocity within a predetermined range.

The cable 260 is connected to a control circuit (not shown) of the rotary motor 240. A control device (e.g., personal computer) (not shown) is connected to the cable 260 so that the rotational speed of the rotary motor 250 can be adjusted via an interface such as a general-purpose interface bus (GPIB).

The rotary motor 240 functions as the rotation control section.

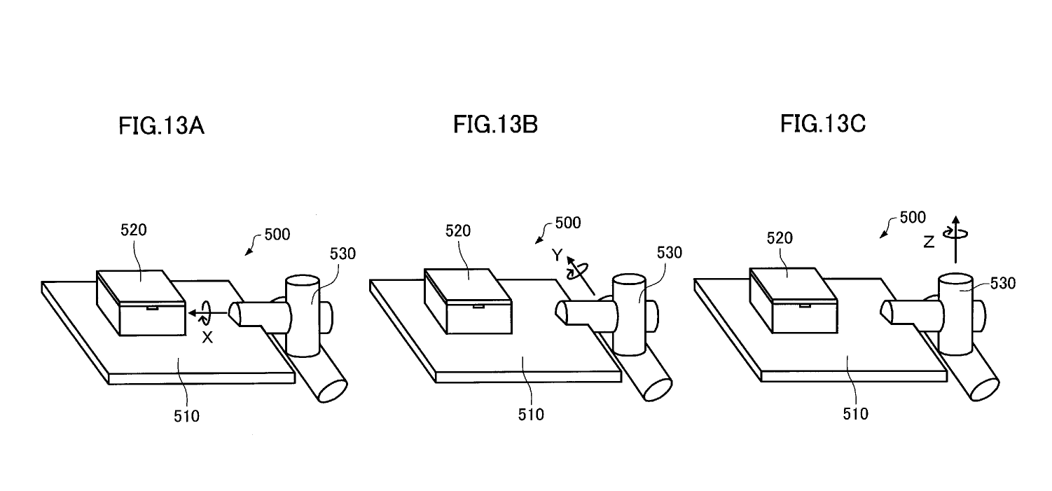

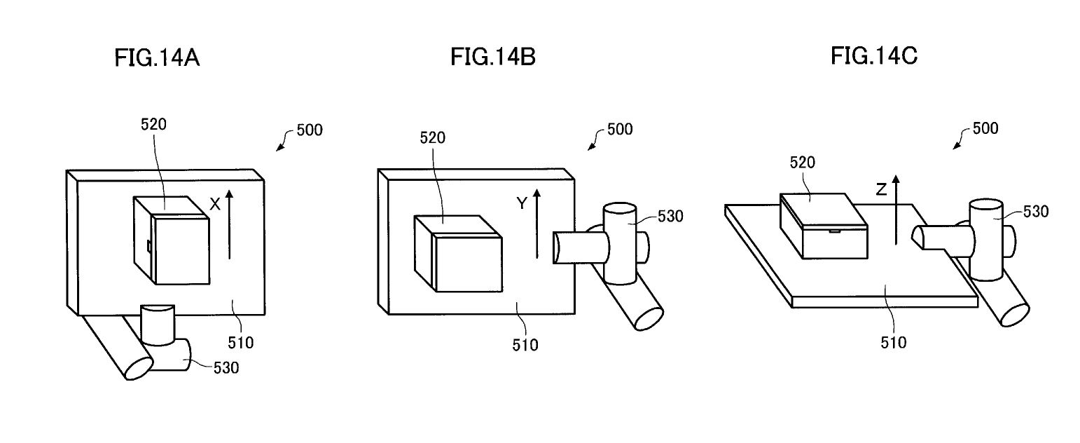

According to this embodiment, since the rotary arm illustrated in FIG. 13A and the like is not required as a result of using the cubic jig 210 and the turntable 230, it is possible to provide the correction parameter creation device 200 that is compact and inexpensive. The correction matrices T_{δx}⁻¹, T_{δy}⁻¹, T_{δz}⁻¹, T_{γx}⁻¹, T_{γy}⁻¹, and T_{γz}⁻¹ can be easily and quickly acquired as described later by utilizing the correction parameter creation device 200 according to this embodiment.

### 2-4. Correction Parameter Creation Process

An example of a correction parameter (correction matrix) creation process using the correction parameter creation device 200 illustrated in FIG. 8 is described below.

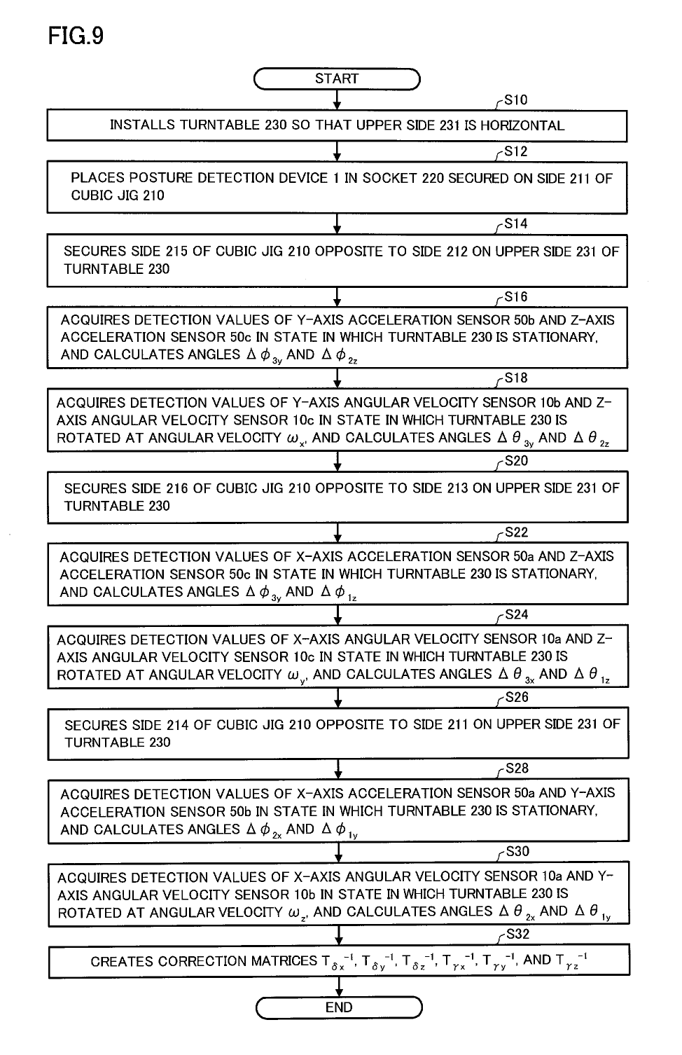

FIG. 9 is a flowchart illustrating an example of a correction parameter creation process according to one embodiment of the invention.

First, the turntable 230 is installed (positioned) so that the upper side 231 is horizontal (step S10).

The posture detection device 1 is placed in the socket 220 secured on the side 211 of the cubic jig 210 (step S12).

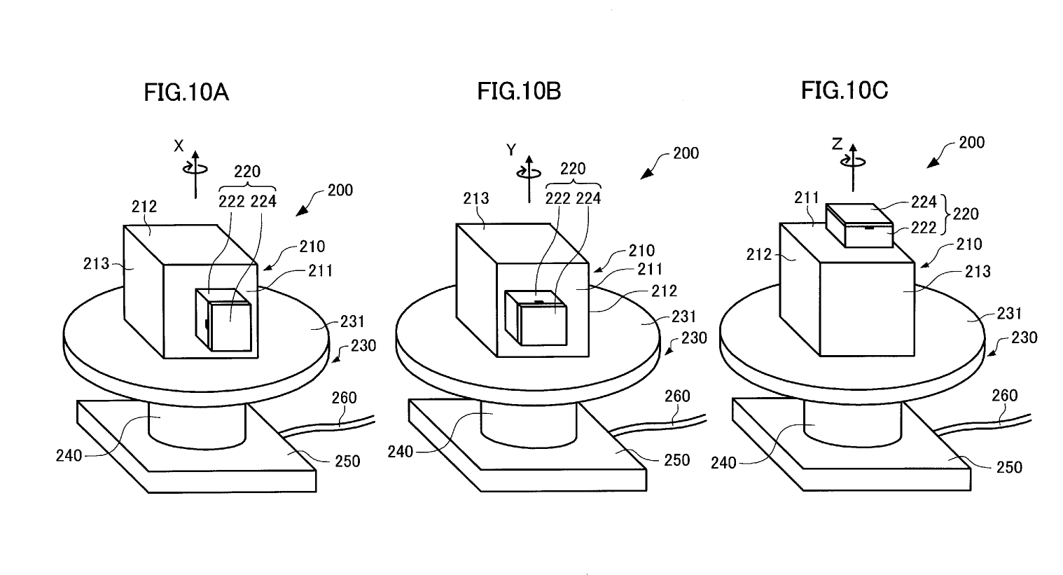

The side 215 of the cubic jig 210 opposite to the side 212 is secured on the upper side 231 of the turntable 230 (step S14). The correction parameter creation device 200 is thus set as shown in FIG. 10A. Specifically, the cubic jig 210 is secured on the turntable 230 so that the positive X-axis direction coincides with the vertically upward direction.

The detection values of the Y-axis acceleration sensor 50b and the Z-axis acceleration sensor 50c are acquired in a state in which the turntable 230 is stationary, and the angles Δφ_{3y} and Δφ_{2z} are calculated using the expressions (30) and (31) (step S16). Specifically, the small velocities Δv_{y′} and Δv_{z′} are calculated by multiplying values obtained by sampling and A/D-converting the detection values A_{y}′ and A_{z}′ of the acceleration sensors 50b and 50c by the sampling cycle Δt. The velocities Δv_{y′} and Δv_{z′} respectively correspond to the velocity Δv_{yy′} in the expression (30) and the velocity Δv_{zz′} in the expression (31). Since a gravitational acceleration g is applied to the acceleration sensors 50b and 50c in the negative X-axis direction, the velocity Δvₓ in the expressions (30) and (31) is −g×Δt. Therefore, the angles Δφ_{3y} and Δφ_{2z} can be calculated using the expressions (30) and (31).

The detection values of the Y-axis angular velocity sensor 10b and the Z-axis angular velocity sensor 10c are acquired in a state in which the turntable 230 is rotated at an angular velocity ωₓ, and the angles Δθ_{3y} and Δθ_{2z} are calculated using the expressions (17) and (18) (step S18). Specifically, the small rotation angles Δθ_{y′} and Δθ_{z′} are calculated by multiplying values obtained by sampling and A/D-converting the detection values G_{y}′ and G_{z}′ of the angular velocity sensors 10b and 10c by the sampling cycle Δt. The rotation angles Δθ_{y′} and Δθ_{z′} respectively correspond to the angle Δθ_{yy′} in the expression (17) and the angle Δθ_{zz′} in the expression (18). Since the angular velocity sensors 10b and 10c are rotated at the angular velocity ωₓ around the X-axis, the angle Δθₓ in the expressions (17) and (28) is ωₓ×Δt. Therefore, the angles Δθ_{3y} and Δθ_{2z} can be calculated using the expressions (17) and (18).

The side 216 of the cubic jig 210 opposite to the side 213 is then secured on the upper side 231 of the turntable 230 (step S20). The correction parameter creation device 200 is thus set as shown in FIG. 10B. Specifically, the cubic jig 210 is secured on the turntable 230 so that the positive Y-axis direction coincides with the vertically upward direction.

The detection values of the X-axis acceleration sensor 50a and the Z-axis acceleration sensor 50c are acquired in a state in which the turntable 230 is stationary, and the angles Δφ₃ₓ and Δφ_{1z} are calculated using the expressions (32) and (33) (step S22). The process in the step S22 is similar to the process in the step S16. Therefore, description thereof is omitted.

The detection values of the X-axis angular velocity sensor 10a and the Z-axis angular velocity sensor 10c are acquired in a state in which the turntable 230 is rotated at an angular velocity ω_{y}, and the angles Δθ₃ₓ and Δθ_{1z} are calculated using the expressions (19) and (20) (step S24). The process in the step S24 is similar to the process in the step S18. Therefore, description thereof is omitted.

The side 214 of the cubic jig 210 opposite to the side 211 is then secured on the upper side 231 of the turntable 230 (step S26). The correction parameter creation device 200 is thus set as shown in FIG. 10C. Specifically, the cubic jig 210 is secured on the turntable 230 so that the positive Z-axis direction coincides with the vertically upward direction.

The detection values of the X-axis acceleration sensor 50a and the Y-axis acceleration sensor 50b are acquired in a state in which the turntable 230 is stationary, and the angles Δφ₂ₓ and Δφ_{1y} are calculated using the expressions (34) and (35) (step S28). The process in the step S28 is similar to the process in the step S16. Therefore, description thereof is omitted.

The detection values of the X-axis angular velocity sensor 10a and the Y-axis angular velocity sensor 10b are acquired in a state in which the turntable 230 is rotated at an angular velocity ω_{z}, and the angles Δθ₂ₓ and Δθ_{1y} are calculated using the expressions (21) and (22) (step S30). The process in the step S30 is similar to the process in the step S18. Therefore, description thereof is omitted.

The correction matrices T_{δx}⁻¹, T_{δy}⁻¹, T_{δz}⁻¹, T_{γx}⁻¹, T_{γy}⁻¹, and T_{γz}⁻¹ are then created (step S32). Specifically, the correction matrix T_{δx}⁻¹ is created by calculating the inverse matrix of the transformation matrix T_{δx} obtained by substituting the angles Δθ₃ₓ and Δθ₂ₓ calculated by the steps S24 and S30 into the expression (10). Likewise, the correction matrix T_{δy}⁻¹ is created by calculating the inverse matrix of the transformation matrix T_{δy} obtained by substituting the angles Δθ_{3y} and Δθ_{1y} calculated by the steps S18 and S30 into the expression (11). The correction matrix T_{δz}⁻¹ is created by calculating the inverse matrix of the transformation matrix T_{δz} obtained by substituting the angles Δθ_{2z} and Δθ_{1z} calculated by the steps S18 and S24 into the expression (12). The correction matrix T_{δx}⁻¹ is created by calculating the inverse matrix of the transformation matrix T_{γx} obtained by substituting the angles Δφ₃ₓ and Δφ₂ₓ calculated by the steps S22 and S28 into the expression (24). The correction matrix T_{γy}⁻¹ is created by calculating the inverse matrix of the transformation matrix T_{γy} obtained by substituting the angles Δφ_{3y} and Δφ_{1y} calculated by the steps S16 and S28 into the expression (25). The correction matrix T_{γz}⁻¹ is created by calculating the inverse matrix of the transformation matrix T_{γz} obtained by substituting the angles Δφ_{2z} and Δφ_{1z} calculated by the steps S16 and S22 into the expression (26).

Note that the above process is performed by a personal computer or the like connected to the cable 260 of the correction parameter creation device 200. The correction parameters created by the process according to this embodiment are used in a correction calculation task implemented by a user-side microcomputer connected in the subsequent stage of the posture detection device 1, for example.

According to this embodiment, the posture detection device 1 can be easily secured on the side 211 so that the X-axis, the Y-axis, and the Z-axis perpendicularly intersect the sides 212, 213, and 211 of the cubic jig 210, respectively. If the turntable 230 is installed so that the upper side 231 is horizontal, the X-axis, the Y-axis, or the Z-axis can be easily made parallel to the vertical direction by merely securing the side 215, 216, or 214 of the cubic jig 210 on the upper side 231 of the turntable 230. The detection values of the acceleration sensors 50a, 50b, and 50c can be easily and quickly acquired in a state in which the turntable 230 is stationary, and the detection values of the angular velocity sensors 10a, 10b, and 10c can be easily and quickly acquired by rotating the turntable 230 in a state in which the X-axis, the Y-axis, or the Z-axis is parallel to the vertical direction.

Since the rotation direction of the turntable 230 is fixed by initially installing the turntable 230 so that the upper side 231 is horizontal, the setting time for acquiring the detection values about the X-axis, the Y-axis, and the Z-axis can be significantly reduced. Therefore, the correction matrices T_{δx}⁻¹, T_{δy}⁻¹, T_{δz}⁻¹, T_{γx}⁻¹, T_{γy}⁻¹, and T_{γz}⁻¹ can be created at low cost.

Note that the correction matrix T_{δx}⁻¹ for the X-axis angular velocity sensor 10a is created based on the detection value of the X-axis angular velocity sensor 10a rotated around the Y-axis and the Z-axis, for example. Therefore, the correction parameter is created taking account of the installation angle errors and the axis sensitivity errors with respect to each detection axis.

The correction parameters created by the process according this embodiment may be used to correct the detection values of a posture detection device that is incorporated in various electronic instruments, such as a device that detects and controls the posture of a moving object or a robot, a head mount display used for virtual reality or the like, a tracker that detects the posture of a head, a game machine that utilizes a 3D game pad or the like, a digital camera, a mobile phone, a portable information terminal, and a car navigation system.

### 3. Posture Detection Device Having Correction Function

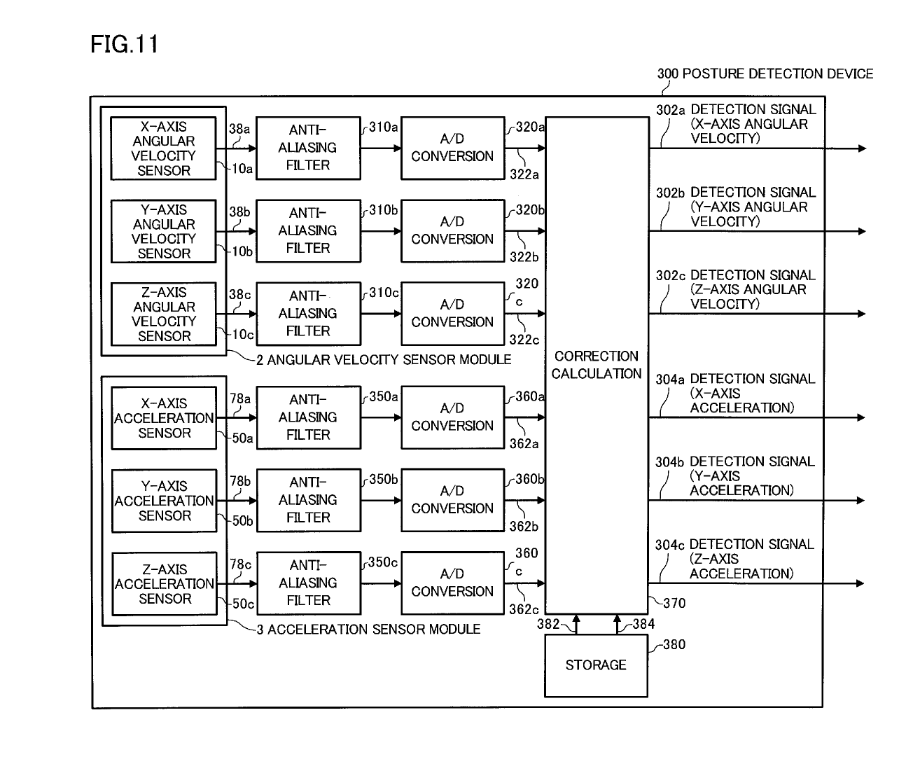

FIG. 11 is a diagram illustrating the configuration of a posture detection device according to one embodiment of the invention.

A posture detection device 300 having a correction function illustrated in FIG. 11 includes an angular velocity sensor module 2, an acceleration sensor module 3, anti-aliasing filters 310a, 310b, 310c, 350a, 350b, and 350c, A/D conversion circuits 320a, 320b, 320c, 360a, 360b, and 360c, a correction calculation section 370, and a storage section 380.

The angular velocity sensor module 2 and the acceleration sensor module 3 are configured in the same manner as in FIGS. 1 and 2. Therefore, description thereof is omitted.

The anti-aliasing filters 310a, 310b, 310c, 350a, 350b, and 350c are disposed in the preceding stage of the A/D conversion circuits 320a, 320b, 320c, 360a, 360b, and 360c, respectively. The anti-aliasing filters 310a, 310b, 310c, 350a, 350b, and 350c attenuate noise that folds back to a DC frequency band due to sampling by the A/D conversion circuits 320a, 320b, 320c, 360a, 360b, and 360c from angular velocity detection signals 38a, 38b, and 38c and acceleration detection signals 78a, 78b, and 78c so that the noise can be ignored.

The anti-aliasing filters 310a, 310b, 310c, 350a, 350b, and 350c may be a switched-capacitor filter (SCF), for example.

The A/D conversion circuits 320a, 320b, 320c, 360a, 360b, and 360c convert the angular velocity detection signals 38a, 38b, and 38c and the acceleration detection signals 78a, 78b, and 78c that have been filtered by the anti-aliasing filters 310a, 310b, 310c, 350a, 350b, and 350c into angular velocity detection signals 322a, 322b, and 322c and acceleration detection signals 362a, 362b, and 362c represented by a predetermined number of bits, respectively. The A/D conversion circuits 320a, 320b, 320c, 360a, 360b, and 360c function as the A/D conversion section, and may be formed by a flash (parallel comparison) AD conversion circuit, a pipeline AD conversion circuit, a successive approximation AD conversion circuit, a delta sigma AD conversion circuit, or the like.

The storage section 380 stores angular velocity sensor correction parameters 382 and acceleration sensor correction parameters 384. Specifically, the correction parameters 382 include the correction matrices T_{δx}⁻¹, T_{δy}⁻¹, and T_{δz}⁻¹, and the correction parameters 384 include the correction matrices T_{γx}⁻¹, T_{γy}⁻¹, and T_{γz}⁻¹.

The correction calculation section 370 calculates the correction expression (23) based on the angular velocity detection signals 322a, 322b, and 322c and the correction parameters 382 to generate angular velocity detection signals 302a, 302b, and 302c obtained by correcting the errors of the angular velocity detection signals 38a, 38b, and 38c due to the installation angle errors of the angular velocity sensors 10a, 10b, and 10c. Specifically, the correction calculation section 370 calculates the small rotation angles Δθₓ, Δθ_{y}, and Δθ_{z} by substituting values obtained by multiplying the digital values of the angular velocity detection signals 322a, 322b, and 322c by the A/D conversion sampling cycle Δt for the small rotation angles Δθ_{x′}, Δθ_{y′}, and Δθ_{z′} in the correction expression (23), and dividing the rotation angles Δθₓ, Δθ_{y}, and Δθ_{z} by the sampling cycle Δt to generate the angular velocity detection signals 302a, 302b, and 302c.

The correction calculation section 370 calculates the correction expression (37) based on the acceleration detection signals 362a, 362b, and 362c and the correction parameters 384 to generate angular velocity detection signals 304a, 304b, and 304c obtained by correcting the errors of the acceleration detection signals 78a, 78b, and 78c due to the installation angle errors of the acceleration sensors 50a, 50b, and 50c. Specifically, the correction calculation section 370 calculates the small velocities Δvₓ, Δv_{y}, and Δv_{z} by substituting values obtained by multiplying the digital values of the acceleration detection signals 362a, 362b, and 362c by the A/D conversion sampling cycle Δt for the small velocities Δv_{x′}, Δv_{y′}, and Δv_{z′} in the correction expression (37), and dividing the velocities Δvₓ, Δv_{y}, and Δv_{z} by the sampling cycle Δt to generate the angular velocity detection signals 304a, 304b, and 304c.

The correction calculation section 370 may be implemented by a dedicated circuit that performs the correction calculation process, or the function of the correction calculation section 370 may be implemented causing a central processing unit (CPU) to execute a program stored in the storage section 380 or the like.

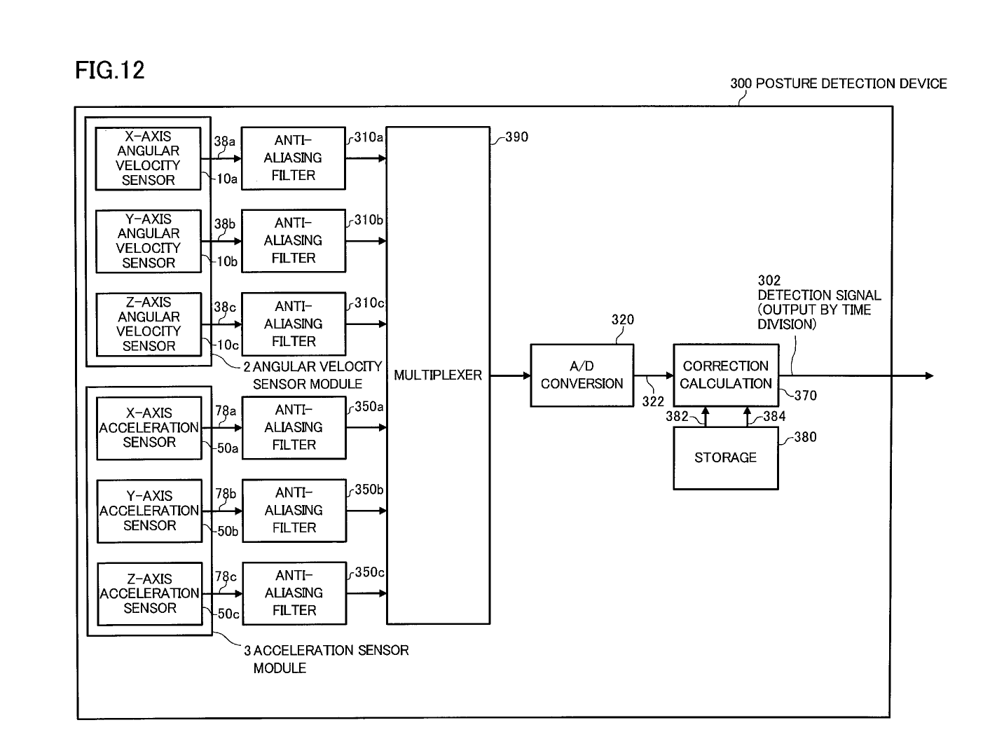

FIG. 12 is a diagram illustrating another configuration of the posture detection device according to this embodiment.

The angular velocity sensor module 2, the acceleration sensor module 3, the anti-aliasing filters 310a, 310b, 310c, 350a, 350b, and 350c, and the storage section 380 illustrated in FIG. 12 are configured in the same manner as in FIG. 11. Therefore, description thereof is omitted

A multiplexer 390 sequentially selects the angular velocity detection signals 38a, 38b, and 38c and the acceleration detection signals 78a, 78b, and 78c that have been filtered by the anti-aliasing filters 310a, 310b, 310c, 350a, 350b, and 350c by time division in a predetermined cycle.

An A/D conversion circuit 320 converts the signal selected by the multiplexer 390 into a detection signal 322 represented by a predetermined number of bits. The A/D conversion circuit 320 and the multiplexer 390 respectively function as the A/D conversion section and the signal selection section.

The correction calculation section 370 samples the detection signal 322 in a predetermined cycle, generates a corrected angular velocity detection signal by calculating the correction expression (23) based on the detection signal 322 and the correction parameters 382 when the detection signal 322 corresponds to the angular velocity detection signal 38a, 38b, or 38c, and outputs the corrected angular velocity detection signal by time division as the detection signal 322.

The correction calculation section 370 generates a corrected acceleration detection signal by calculating the correction expression (37) based on the detection signal 322 and the correction parameters 384 when the detection signal 322 corresponds to the acceleration detection signal 78a, 78b, or 78c, and outputs the corrected acceleration detection signal by time division as the detection signal 322.

If the posture detection device 300 illustrated in FIG. 11 or 12 has a bypass mode in which the output from the A/D conversion circuit 320a or the like can be output to the outside while bypassing the correction calculation section 370, the correction parameters 382 and 384 can be created in the bypass mode using the correction parameter creation method according to one embodiment of the invention. Specifically, the correction parameter creation method according to one embodiment of the invention may also be applied to the posture detection device 300.

Since the correction calculation section 370 calculates the corrected values using the correction expressions (23) and (37) that can implement an increase in correction accuracy and an increase in correction calculation speed, a posture detection device that achieves high correction accuracy and a high correction calculation speed can be implemented.

Since a user-side microcomputer connected in the subsequent stage of the posture detection device 300 need not perform the correction calculation process, it is convenient for the user from the viewpoint of task encapsulation.

Since the posture detection device 300 outputs a digitized sensor detection signal, it is unnecessary to provide an A/D conversion circuit between the posture detection device 300 and the user-side microcomputer.

The posture detection device 300 according to this embodiment may be incorporated in various electronic instruments such as a device that detects and controls the posture of a moving object or a robot, a head mount display used for virtual reality or the like, a tracker that detects the posture of a head, a game machine that utilizes a 3D game pad or the like, a digital camera, a mobile phone, a portable information terminal, and a car navigation system.

Note that the invention is not limited to the above embodiments. Various modifications and variations may be made without departing from the scope of the invention.

For example, a posture detection device to which the correction parameter creation method according to one embodiment of the invention is applied is not limited to the posture detection device illustrated in FIG. 1 that includes the angular velocity sensors 10a, 10b, and 10c and the acceleration sensors 50a, 50b, and 50c. Specifically, it suffices that a posture detection device to which the correction parameter creation method according to one embodiment of the invention is applied detect angular velocities around three orthogonal axes or accelerations in three orthogonal axis directions. For example, the correction parameter creation method according to one embodiment of the invention may be applied to a posture detection device that includes only the angular velocity sensors 10a, 10b, and 10c, a posture detection device that includes only the acceleration sensors 50a, 50b, and 50c, a posture detection device that includes only the angular velocity sensors 10a and 10b and the acceleration sensor 50c, a posture detection device that includes only the angular velocity sensor 10a and the acceleration sensors 50b and 50c, and the like.

In the correction parameter creation device 200 illustrated in FIG. 8, one socket 220 is secured on the side 211. Note that a plurality of sockets 220 may be secured on the side 211. The detection values of a plurality of posture detection devices 1 can be acquired at the same time by respectively placing the plurality of posture detection devices 1 in the plurality of sockets 220.

In the process illustrated in FIG. 9, the detection values of the posture detection device 1 are acquired in the order of the X-axis, the Y-axis, and the Z-axis. Note that the detection values of the posture detection device 1 may be acquired in an arbitrary order.

The invention includes configurations that are substantially the same as the configurations described in the above embodiments (e.g., in function, method and effect, or objective and effect). The invention also includes a configuration in which an unsubstantial element among the elements described in connection with the above embodiments is replaced with another element. The invention also includes a configuration having the same effects as those of the configurations described in connection with the above embodiments, or a configuration that can achieve the same object as that of the configurations described in connection with the above embodiments. The invention also includes a configuration obtained by adding known technology to the configurations described in connection with the above embodiments.

### REFERENCE SIGNS LIST

1: posture detection device, 2: angular velocity sensor module, 3: acceleration sensor module, 4: package, 5a, 5b, 5c: side of package, 10a, 10b, 10c: angular velocity sensor, 11a, 11b, 11c: vibrator, 12a, 12b, 12c: drive electrode, 13a, 13b, 13c: drive electrode, 14a, 14b, 14c: detection electrode, 15a, 15b, 15c: detection electrode, 20a, 20b, 20c: driver circuit, 21a: current/voltage converter (I/V converter), 22a: AC amplifier, 23a: automatic gain control circuit (AGC), 24a: comparator, 30a, 30b, 30c: detection circuit, 31a, 32a: charge amplifier, 33a: differential amplifier, 34a: AC amplifier, 35a: synchronous detection circuit, 36a: DC amplifier, 37a: integration circuit (LPF), 38a, 38b, 38c: detection signal, 41a: drive vibrating arm, 42a: detection vibrating arm, 43a: wide section, 44a: drive base, 45a: connection arm, 46a: wide section, 47a: detection base, 50a, 50b, 50c: acceleration sensor, 51a, 51b, 51c: vibrator, 52a, 52b, 52c: drive electrode, 53a, 53b, 53c: drive electrode, 54a, 54b, 54c: detection electrode, 55a, 55b, 55c: detection electrode, 56a, 56b, 56c: base end, 57a, 57b, 57c: base end, 58a, 58b, 58c: drive vibrating arm, 60a, 60b, 60c: driver circuit, 70a, 70b, 70c: detection circuit, 78a, 78b, 78c: detection signal, 80: insulating substrate, 82a, 82b, 82c: package, 84a, 84b, 84c: package main body, 86a, 86b, 86c: lid, 90: base, 91, 92, 93: mounting surface, 100: weight, 101, 102, 103: bonding surface, 200: correction parameter creation device, 210: cubic jig, 211, 212, 213, 214, 215, 216: side of cubic jig, 220: socket, 222: socket main body, 224: lid, 230: turntable, 231: upper side of turntable, 240: rotary motor, 250: support stage, 260: cable, 300: posture detection device, 302, 302a, 302b, 302c: detection signal, 304a, 304b, 304c: detection signal, 310a, 310b, 310c: anti-aliasing filter, 310a, 310b, 310c: A/D conversion circuit, 320: A/D conversion circuit, 322a, 322b, 322c: detection signal, 350a, 350b, 350c: anti-aliasing filter, 360a, 360b, 360c: A/D conversion circuit, 362a, 362b, 362c: detection signal, 370: correction calculation section, 380: storage section, 382: correction parameter, 384: correction parameter, 390: multiplexer, 500: correction parameter creation device, 510: table, 520: socket, 530: rotary arm

1.-8. (canceled)

9. A correction parameter creation method that creates correction parameters of a correction expression that corrects detection values of a posture detection device to detection values in an orthogonal coordinate system having a first axis, a second axis, and a third axis that perpendicularly intersect as coordinate axes, the posture detecting device including a first sensor, a second sensor, and a third sensor that are mounted so that their detection axes are almost parallel to the first axis, the second axis, and the third axis, respectively, and detect an angular velocity or an acceleration, and detecting a posture of an object based on detection signals from the first sensor, the second sensor, and the third sensor, the correction parameter creation method comprising:
a step of installing a turntable so that an upper side of the turntable is horizontal;
a step of securing the posture detection device on a first side of a jig that is formed in a shape of a rectangular parallelepiped and includes the first side, a second side, and a third side that perpendicularly intersect so that the first axis perpendicularly intersects the second side, the second axis perpendicularly intersects the third side, and the third axis perpendicularly intersects the first side;
a first detection value acquisition step of securing a side of the jig opposite to the second side on the upper side of the turntable, and acquiring the detection values of the posture detection device in a state in which the turntable is stationary or rotated at a predetermined angular velocity;
a second detection value acquisition step of securing a side of the jig opposite to the third side on the upper side of the turntable, and acquiring the detection values of the posture detection device in a state in which the turntable is stationary or rotated at a predetermined angular velocity;
a third detection value acquisition step of securing a side of the jig opposite to the first side on the upper side of the turntable, and acquiring the detection values of the posture detection device in a state in which the turntable is stationary or rotated at a predetermined angular velocity; and
a correction parameter creation step of creating the correction parameters based on the acquired detection values.

10. The correction parameter creation method according to claim 9,
wherein the correction expression includes a first correction matrix, a second correction matrix, and a third correction matrix as the correction parameters, the first correction matrix, the second correction matrix, and the third correction matrix correcting the detection values of the first sensor, the second sensor, and the third sensor to the detection values in the orthogonal coordinate system, the correction expression being the sum of three matrices obtained by the product of the first correction matrix and a matrix that includes a digital value obtained by A/D-converting the detection value of the first sensor as an element, the product of the second correction matrix and a matrix that includes a digital value obtained by A/D-converting the detection value of the second sensor as an element, and the product of the third correction matrix and a matrix that includes a digital value obtained by A/D-converting the detection value of the third sensor as an element.

11. The correction parameter creation method according to claim 10,
wherein the first correction matrix is an inverse matrix of a rotation matrix that transforms the detection axis of the first sensor into the first axis, the second correction matrix is an inverse matrix of a rotation matrix that transforms the detection axis of the second sensor into the second axis, and the third correction matrix is an inverse matrix of a rotation matrix that transforms the detection axis of the third sensor into the third axis.

12. The correction parameter creation method according to claim 10,
wherein the correction parameter creation step includes:
calculating installation angle errors of the second sensor and the third sensor around the first axis based on the detection values acquired in the first detection value acquisition step;
calculating installation angle errors of the first sensor and the third sensor around the second axis based on the detection values acquired in the second detection value acquisition step;
calculating installation angle errors of the first sensor and the second sensor around the third axis based on the detection values acquired in the third detection value acquisition step;
creating the first correction matrix based on the installation angle error of the first sensor around the second axis and the installation angle error of the first sensor around the third axis;
creating the second correction matrix based on the installation angle error of the second sensor around the first axis and the installation angle error of the second sensor around the third axis; and
creating the third correction matrix based on the installation angle error of the third sensor around the first axis and the installation angle error of the third sensor around the second axis.

13. The correction parameter creation method according to claim 11,
wherein the correction parameter creation step includes:
calculating installation angle errors of the second sensor and the third sensor around the first axis based on the detection values acquired in the first detection value acquisition step;
calculating installation angle errors of the first sensor and the third sensor around the second axis based on the detection values acquired in the second detection value acquisition step;
calculating installation angle errors of the first sensor and the second sensor around the third axis based on the detection values acquired in the third detection value acquisition step;
creating the first correction matrix based on the installation angle error of the first sensor around the second axis and the installation angle error of the first sensor around the third axis;
creating the second correction matrix based on the installation angle error of the second sensor around the first axis and the installation angle error of the second sensor around the third axis; and
creating the third correction matrix based on the installation angle error of the third sensor around the first axis and the installation angle error of the third sensor around the second axis.

14. A correction parameter creation device that is used to create correction parameters of a correction expression that corrects detection values of a posture detection device to detection values in an orthogonal coordinate system having a first axis, a second axis, and a third axis that perpendicularly intersect as coordinate axes, the posture detection device including a first sensor, a second sensor, and a third sensor that are mounted so that their detection axes are almost parallel to the first axis, the second axis, and the third axis, respectively, and detect an angular velocity or an acceleration, and detecting a posture of an object based on detection signals from the first sensor, the second sensor, and the third sensor, the correction parameter creation device comprising:
a jig that is formed in a shape of a rectangular parallelepiped, and includes a first side, a second side, and a third side that perpendicularly intersect, the jig being configured so that the posture detection device can be secured on the first side such that the first axis perpendicularly intersects the second side, the second axis perpendicularly intersects the third side, and the third axis perpendicularly intersects the first side;
a turntable having an upper side on which a side of the jig opposite to the first side, the second side, or the third side can be secured; and
a rotation control section that rotates the turntable at a predetermined angular velocity.

15. A posture detection device comprising:
a first sensor, a second sensor, and a third sensor that are mounted so that their detection axes are almost parallel to a first axis, a second axis, and a third axis that perpendicularly intersect, respectively, and detect an angular velocity or an acceleration;
a storage section that stores correction parameters of a correction expression that corrects detection values of the first sensor, the second sensor, and the third sensor to detection values in an orthogonal coordinate system having the first axis, the second axis, and the third axis as coordinate axes;
an A/D conversion section that converts detection signals from the first sensor, the second sensor, and the third sensor into digital signals; and
a correction calculation section that calculates the correction expression based on the digital signals and the correction parameters,
the correction expression including a first correction matrix, a second correction matrix, and a third correction matrix as the correction parameters, the first correction matrix, the second correction matrix, and the third correction matrix correcting the detection values of the first sensor, the second sensor, and the third sensor to the detection values in the orthogonal coordinate system, and being the sum of three matrices obtained by the product of the first correction matrix and a matrix that includes a digital value obtained by A/D-converting the detection value of the first sensor as an element, the product of the second correction matrix and a matrix that includes a digital value obtained by A/D-converting the detection value of the second sensor as an element, and the product of the third correction matrix and a matrix that includes a digital value obtained by A/D-converting the detection value of the third sensor as an element.

16. The posture detection device according to claim 15,
wherein the first correction matrix is an inverse matrix of a rotation matrix that transforms the detection axis of the first sensor into the first axis, the second correction matrix is an inverse matrix of a rotation matrix that transforms the detection axis of the second sensor into the second axis, and the third correction matrix is an inverse matrix of a rotation matrix that transforms the detection axis of the third sensor into the third axis.

17. The posture detection device according to claim 15, further comprising:
a signal selection section that sequentially selects one of the detection signals from the first sensor, the second sensor, and the third sensor in a predetermined cycle,
wherein the A/D conversion section includes an A/D conversion circuit that sequentially A/D-converts the detection signal selected by the signal selection section.

18. The posture detection device according to claim 16, further comprising:
a signal selection section that sequentially selects one of the detection signals from the first sensor, the second sensor, and the third sensor in a predetermined cycle,
wherein the A/D conversion section includes an A/D conversion circuit that sequentially A/D-converts the detection signal selected by the signal selection section.
